(19) United States
(12) Patent Application Publication
(10) Pub. No.: US 2026/0073603 A1
(43) Pub. Date: Mar. 12, 2026

(54) Context-Based Animated Image Generation from a Video

(71) Applicant: Google LLC, Mountain View, CA (US)

(72) Inventors: Vishu Goyal, Mountain View, CA (US); Rosemond Gerold Dorleans, San Francisco, CA (US)

(21) Appl. No.: 18/826,948

(22) Filed: Sep. 6, 2024

(51) Int. Cl. G06T 13/40

(52) U.S. Cl. CPC G06T 13/40

(57) ABSTRACT

Systems and methods for animated image generation can obtain user-generated content, perform a video segment search based on the user-generated content, process the video segment to generate an animated image, and provide the animated image as an output. The systems and methods can perform sentiment analysis, audio transcription, key frame extraction, and sequence-based rendering to perform the animated image generation.

### FIELD

The present disclosure relates generally to generating animated images (e.g., GIFs) based on a user input. More particularly, the present disclosure relates to determining and generating animated images that may be applicable to a provided user input and incorporating them into the user’s generated content at their request.

### BACKGROUND

Graphics interchange format files (GIFs) are a heavily utilized form of media sharing that require extensive human resources to create and curate. GIFs allow for the dissemination of information in a quick and concise manner without the larger data requirements of video and can provide visual information that textual data cannot. However, given their short, animated nature, GIFs require almost complete manual creation to exist. In order to create a GIF, a user must either create new animations frame-by-frame or cut down and convert previously created videos or animations to their desired length and fidelity. The process of creating GIFs can be tedious and, as demand for them grows, increasingly costly with regards to time and energy.

GIFs are commonly used as a supplement to textual information to elicit emotion from, or emphasis on, information that the text alone cannot create. GIFs are frequently utilized in messaging services and social media posts to enhance the user experience by providing added dimensionality to their digital communication. However, while the corpus of GIFs may be large, the corpus of GIFs does not always contain the right item for every situation. Users will frequently have to settle on the closest item to what they intend or forgo inclusion of a GIF item entirely depending on the message they aim to convey and what items are available. The lack of relevant media content items (e.g., GIFs) can be more prominent when the situation relates to current events and more niche interests or media.

Understanding search results from a search results page can be difficult as titles and text snippets may provide limited information that may not be associated with the user’s interest, which can lead to a time consuming web resource review that may not yield the desired information. Obtaining additional information on web resources can be difficult, which may include an additional search that may or may not identify relevant information.

Additionally, obtaining user insights can be difficult. In particular, users may struggle to determine which words to use. Additionally, the words may not be directed to a point-of-interest for other users and/or may not be abundant enough to generate desired results.

### SUMMARY

Aspects and advantages of embodiments of the present disclosure will be set forth in part in the following description, or can be learned from the description, or can be learned through practice of the embodiments.

One example aspect of the present disclosure is directed to a computing system for generating animated images. The system can include one or more processors and one or more non-transitory computer-readable media that collectively store instructions that, when executed by the one or more processors, cause the computing system to perform operations. The operations can include obtaining, via a link notes interface, user-generated content data. The user-generated content data can include a text string input by a user. The link notes interface can include a user interface that is configured to receive inputs to generate user generated link notes to index with web resources. The operations can include obtaining, via the link note interface, video data. The video data can include a plurality of image frames and audio data. The operations can include processing the user-generated content data and the video data to determine a subset of frames of the plurality of image frames are associated with the user-generated content data. The operations can include processing the subset of frames of the plurality of image frames to generate an animated image. The animated image can include an animated playback of the subset of frames ordered sequentially. The operations can include providing the animated image for display via the link notes interface.

In some implementations, the operations can include obtaining a selection of the animated image and augmenting, based on the selection of the animated image, a link note to include the animated image and the text string input. Processing the subset of frames of the plurality of image frames to generate the animated image can include processing the audio data to transcribe at least a portion of the audio data associated with the subset of frames to generate a partial transcript and rendering the partial transcript over the subset of frames. In some implementations, the user-generated content data can include a link note. The link note can be descriptive of a comment left by one or more other users linked to a web resource. The link note can be provided for display when the web resource is provided as a search result.

In some implementations, processing the user-generated content data and the video data to determine the subset of frames of the plurality of image frames are associated with the user-generated content data can include processing the audio data with a transcription model to generate a transcript for the video data and processing the transcript and the text string input with a machine-learned language model to determine the subset of frames of the plurality of image frames. Obtaining, via the link notes interface, the user-generated content data can include receiving the text string input with a freeform input box provided by the link notes interface. Providing the animated image for display via the link notes interface can include providing the animated image for display within the freeform input box adjacent to the text string input.

In some implementations, the operations can include generating a graphical card based on the text string input and the animated image. The graphical card can include a stylized format of the text string input and the animated image. The operations can include indexing the graphical card with resource data associated with a particular web resource. In some implementations, the operations can include obtaining a search query, determining the particular web resource is responsive to the search query, and generating a search results interface that includes a title for the particular web resource, a text snippet from the particular web resource, a hyperlink to access the particular web resource, and the graphical card. The animated image can be configured in a graphics interchange format.

Another example aspect of the present disclosure is directed to a computer-implemented method for generating animated images. The method can include obtaining, by a computing system including one or more processors and via a link notes interface, user-generated content data. The user-generated content data can include a text string input by a user. The link notes interface can include a user interface that is configured to receive inputs to generate user generated link notes to index with web resources. The method can include obtaining, by the computing system and from a video database, a video based on the text string input. The video can include a plurality of image frames and audio data. In some implementations, the video database can include a plurality of different videos. The method can include processing, by the computing system, the user-generated content data and the video to determine a subset of frames of the plurality of image frames are associated with the user-generated content data. The method can include processing, by the computing system, the subset of frames of the plurality of image frames to generate an animated image. The animated image can include an animated playback of the subset of frames ordered sequentially. The method can include providing, by the computing system, the animated image for display via the link notes interface.

In some implementations, the video database can include a user-specific video database that stores videos saved by the user. The video database can include a historical log of videos recently viewed by the user. In some implementations, processing, by the computing system, the user-generated content data and the video to determine the subset of frames of the plurality of image frames are associated with the user-generated content data can include determining, by the computing system, a particular sentiment of the text string input and determining, by the computing system, the subset of frames of the plurality of image frames are associated with the particular sentiment.

In some implementations, processing, by the computing system, the user-generated content data and the video to determine the subset of frames of the plurality of image frames are associated with the user-generated content data can include determining, by the computing system, a particular topic of the text string input and determining, by the computing system, the subset of frames of the plurality of image frames are associated with the particular topic.

In some implementations, processing, by the computing system, the user-generated content data and the video to determine the subset of frames of the plurality of image frames are associated with the user-generated content data can include determining, by the computing system, a particular action of the text string input and determining, by the computing system, the subset of frames of the plurality of image frames includes a sequence of frames of an individual performing the particular action.

Another example aspect of the present disclosure is directed to one or more non-transitory computer-readable media that collectively store instructions that, when executed by one or more computing devices, cause the one or more computing devices to perform operations. The operations can include obtaining, via a link notes interface, user-generated content data. The user-generated content data can include a text string input by a user. The link notes interface can include a user interface that is configured to receive inputs to generate user generated link notes to index with web resources. The operations can include determining a video includes content associated with at least a subset of text string input. The video data can include a plurality of image frames and audio data. The operations can include processing the user-generated content data and the video to determine a subset of frames of the plurality of image frames are associated with the user-generated content data. The operations can include segmenting the subset of frames of the plurality of image frames from the video based on determining the subset of frames of the plurality of image frames are associated with the user-generated content data. The operations can include processing the subset of frames of the plurality of image frames to generate an animated image. The animated image can include an animated playback of the subset of frames ordered sequentially. The operations can include providing the animated image for display via the link notes interface.

In some implementations, processing the subset of frames of the plurality of image frames to generate the animated image can include processing at least a subset of the text string input with a text-to-image generation model to generate one or more model-generated images. The one or more model-generated images can include a plurality of predicted pixels generated based on the text string input. Processing the subset of frames of the plurality of image frames to generate the animated image can include generating the animated image based on the subset of frames and the one or more model-generated images. The text-to-image generation model can include a diffusion model. In some implementations, the animated image can include the one or more model-generated images interweaved within the subset of frames of the plurality of image frames.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example link note content item generation system according to example embodiments of the present disclosure.

FIG. 2 depicts a block diagram of an example animated image generation system according to example embodiments of the present disclosure.

FIG. 3 depicts a flow chart diagram of an example method to perform animated image generation according to example embodiments of the present disclosure.

FIG. 4 depicts an illustration of an example animated image suggestion interface according to example embodiments of the present disclosure.

FIG. 5 depicts an illustration of an example link note composition interface according to example embodiments of the present disclosure.

FIG. 6 depicts an illustration of an example keyboard interface according to example embodiments of the present disclosure.

FIG. 7 depicts an illustration of an example graphical card interface according to example embodiments of the present disclosure.

FIG. 8 depicts a flow chart diagram of an example method to perform video determination according to example embodiments of the present disclosure.

FIG. 9 depicts a flow chart diagram of an example method to perform segment determination according to example embodiments of the present disclosure.

FIG. 10A depicts a block diagram of an example computing system that performs animated image generation according to example embodiments of the present disclosure.

FIG. 10B depicts a block diagram of an example computing system that performs animated image generation according to example embodiments of the present disclosure.

Reference numerals that are repeated across plural figures are intended to identify the same features in various implementations.

### DETAILED DESCRIPTION

Generally, the present disclosure is directed to systems and methods for generating animated images (e.g., graphics interchange format animated images (GIFs)) based on user generated content (e.g., a user input text string and/or other user-provided content). For example, a user may compose text through different online services such as messaging services (e.g., text, SMS, Direct Message, etc.), social media, blog posts, reviews, and/or link notes that may be utilized to generate short, animated images or video content. The text and the generated animated image can then be leveraged to generate a multimodal content item that can then be shared and/or stored. For instance, a user may compose a message to send to another user, and, with the user’s permission, a system may obtain the user composed message and generate a short, animated image (e.g., a GIF). The user input may be in a variety of formats. For instance, in one example, the user input (e.g., the user-generated content) may solely be text data, however, in another example, the user input may be textual data and visual data, such as a message and one or more attached images. In practice, the user input used to generate animated images (and/or video content) may be of any data type. For instance, as examples, the data types may be text, image, video, audio, latent encodings, metadata, multimodal, and/or other data types.

The short form media content (e.g., the animated images) provided in response to user generated content may be generated in a variety of ways. In some implementations, a system may perform sentiment analysis on provided user content to generate new short form video content and/or animated images. For instance, a user may be composing a blog post discussing a movie that recently came out. The blog post may discuss the user’s overall feelings toward the movie and, in one section, discuss a particular scene of the movie they found interesting. A system may obtain and process the user’s blog post and determine one or more animated images (e.g., GIFs) to go along with the blog post that are generated using frames from the movie discussed in the blog post. In some instances, one of the animated images generated may be from the particular scene in the movie that the user specifically discussed. While the example discusses a source subject of video content, the source may differ, which may include, but is not limited to, a video from local storage on a user computing device, a video obtained from the web, a video from cloud storage, and/or other video databases. In another example, the user may generate a message containing a link to a webpage. The system may obtain and process the message as input and generate one or more animated images based on the webpage linked in the message. The generated one or more animated images may obtain (and/or extract) images from the linked webpage and/or, in some instances, may generate frames based on non-visual data stored within the linked webpage.

In particular, the content being processed may be a link note being composed and/or viewed by the user. Link notes can provide insight on a web resource and/or may provide additional details on a topic of the web resource. The link notes can include user-generated content items and may be aggregated in a link notes interface and/or a collections interface to provide other users with reviews on web resources and/or other knowledge provided by other users. The link notes can be indexed with and/or associated with particular web resources. Link notes can include content (e.g., text, images, video, etc.) added by a user to characterize and/or describe the search result link.

Generating highlight animated images (e.g., graphics interchange format animated images (GIFs)) based on processing a video can provide users with more accessibility to tailoring content items (e.g., social media posts, link notes, blogs, etc.) based on portions of a video. The feature may be provided in a social media interface, a link note interface, and/or a video player extension. For example, a user may be composing a link note, social media post, and/or a message that they desire to include a visual aspect outside of the input text. The systems and methods disclosed herein can be leveraged to generate novel animated images that are based on the user-input text. The generated animated image can then be added to the user generated content item to generate a multimodal content item that can then be posted and/or transmitted.

Videos can be computationally expensive to download and/or view. Additionally, long-form videos may be inaccessible based on the resource cost and/or the time cost of viewing. Moreover, only a portion of the video may be relevant to the contents of the content item. Additionally, the animated image pool is limited, while the video pool is much more expansive.

One or more machine-learned models can process a link context, a user context, a note context, and/or other context data with a video to generate one or more relevant animated images (GIFs). In particular, one or more machine-learned models can be leveraged to generate one or more animated images (GIFs) that may highlight key parts of the video and/or may be based on text within a link note, previous user searches, the contents of a web resource, and/or other contexts. Key frame extraction, large language models, segmentation models, rendering models, augmentation models, and/or other techniques may be performed to generate the animated images.

Animated images can be utilized across social media platforms, blogs, messages, and/or other platforms. The context-based animated imaged generation feature can provide an interface for generating context-relevant GIFs from videos, which can then be utilized for link notes, messaging, and/or other tasks.

The systems and methods may generate the animated images for user uploaded videos, videos with given permissions, and/or other content. In some implementations, images from a web page can be obtained and utilized to generate an animated image. Additionally and/or alternatively an image generation model (e.g., a diffusion model) may be leveraged to generate model-generated images that may be utilized as frames for generating the animated image. For example, images from a web page can be obtained, a text-to-image generation model can be leveraged to generate model-generated images based on the text of the web page, and the images and the model-generated images can be stitched together to generate the animated image.

In some implementations, animated images may be generated and/or suggested based on pre-existing animated images (e.g., pre-existing GIFs in a database). For example, the animated image may be generated based on a video segment being determined to be of similar content type, pacing, and/or semantics to pre-existing animated images within a database (e.g., a server database, and/or a user’s local database of GIFs). In some implementations, the portion of the video leveraged for generating the animated image may be determined based on interaction data (e.g., highly viewed portions of a video, portions of a video viewed by the user, highly rewatched portion of a video, portions of a video that are associated with high frequency of comments, and/or user selections).

In some implementations, the frames of a video may be filtered, enhanced, animated, and/or augmented in another way before animated image generation. For example, subtitles may be overlayed over the frame. Personally identifiable information, gore, and/or nudity may be removed from frames before generating an animated image. For example, an image generation model may be leveraged to generate replacement pixels for portions of a frame that are determined to be sensitive.

Additionally and/or alternatively, the systems and methods may determine a video segment that is associated with a user input. The frames of the video segment can then be processed to determine a set of static frames. A particular frame from the set of static frames may be determined. The particular frame and the remaining dynamic frames can then be utilized to render the animated image. Static frame determination may be determined based on pixel analysis, embedding analysis, and/or other video data processing techniques.

The animated image generation may be performed locally on a user device and/or on a server computing system.

Various computing systems and platforms may utilize short form content creation based on user generated content. For instance, social media platforms, messaging services, text editor plug-ins, blogging platforms, link note platforms, and content curation platforms (e.g., GIF databases, image repositories, etc.) may all utilize user-generated content to generate animated images (e.g., to create short form content). In addition, various computing systems, such as user mobile devices, smartphones, remote computing systems, and general computing devices may generate short form content based on user created content. In some implementations, one or more services may operate on a user computing device, such as a messaging service on a user mobile device. With the user’s permission, the device may send the user’s input within the messaging service to a remote computing device which may then generate one or more short form video content items and send them back to the user computing device. The user may then select one or more of the generated content items to attach with the user-composed message. Additionally, or alternatively, the generation of animated images (and/or short form video content items) may be contained within the mobile computing device. Additionally, in embodiments utilizing a remote computing device, any personally identifying information may be anonymized or scrubbed entirely therefrom before being transmitted to the remote computing device. In some embodiments, any generated content items from user created content may be provided to one or more content curation platforms, such as a GIF curation service, that may utilize the generated content items for other users.

Aspects of the present disclosure can be directed toward solving several technical problems. For instance, videos can be computationally expensive to download or view. Videos require both video and audio data to perform and can take up a significant amount of resources to watch and/or store. As an example, long-form videos may be entirely inaccessible due to resource expenditure required or time cost of viewing. Additionally and/or alternatively, only small portions of a video may be relevant to a user. The resource-expensive nature of videos can frequently lead to them being an unideal solution for users who desire to view and/or transmit information.

Accordingly, aspects of the present disclosure are directed to generating animated images (e.g., a file descriptive of a short form video) based on user-generated content and/or previously available longer form video content. More specifically, aspects of the present disclosure can be directed to utilizing machine-learned models to process link context, user context, note context, and/or other context data associated with a video to generate one or more relevant short form videos or animated images (e.g., GIFs). In particular, machine-learned models may be leveraged to generate one or more animated images that may highlight key parts of a video or generate content based on text within a link note, previous user searches, the contents of a web resource, and/or other contexts.

Aspects of the present disclosure can be directed toward several technical effects and benefits, such as reducing computational resource consumption when generating user content or satisfying user searches. For instance, by generating animated images (and/or short form video content) directly from user-generated content, a user’s search to include short form video content in their posts may be drastically reduced. In addition, the resources relied upon by a user to obtain information that, traditionally may rely on watching an entire video, may be reduced by generating and providing a short form video or animated image to the user which only provides the necessary or relevant information the user needs. Further, generating new short form content based on semantic analysis of long form content may eliminate the need for scraping and analysis of long form content and generation of short form content based therein, which can be incredibly costly in computing resources, electricity, and/or time.

The systems and methods of the present disclosure provide a number of technical effects and benefits. As one example, the system and methods can provide an interactive user interface that can be utilized to generate prompts and obtain user input data. In particular, the systems and methods disclosed herein can leverage one or more machine-learned models to generate animated images for content item generation. For example, a generative model can process user data, content data, and/or other context data to determine a request for information action is to be performed. Additionally and/or alternatively, the generative model may generate a prompt to request information based on the user data, content data, and/or other context data. The prompt can be provided to the user, a user input can be received, and a link note may be generated and stored.

The systems and methods disclosed herein addresses a problem generated by computing systems obtaining, processing, and transmitting data from a plurality of databases from a plurality of sources. The immense volume of data available to users can provide potential for misinformation, misdirection, and/or lack of verification. Text snippets, titles, and/or example images in a search results interface may provide some details on contents of a web resource; however, information from other users can provide further insight on topic, trustworthiness, and/or what to expect, which can be leveraged to reduce instances of irrelevant web resources being navigated and reviewed by the user.

Another example of technical effect and benefit relates to improved computational efficiency and improvements in the functioning of a computing system. For example, the systems and methods disclosed herein can leverage note generation to provide an interface that provides information on links that may mitigate tedious search result review by providing user-based validation. The reduced volume of follow-up queries and the reduced volume of page redirects can reduce latency at the user device and can reduce search engine computational cost.

With reference now to the Figures, example embodiments of the present disclosure will be discussed in further detail.

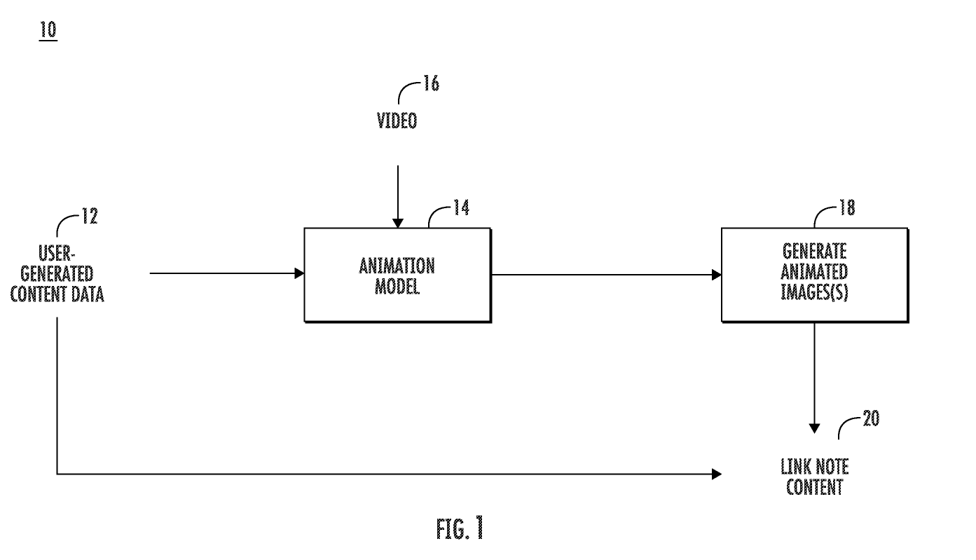

FIG. 1 depicts a block diagram of an example content generation system 10 according to example embodiments of the present disclosure. In some implementations, the content generation system 10 is configured to receive, and/or obtain, a set of user-generated content data 12 descriptive of a user input to the content generating system 10 and, as a result of receipt of the user-generated content data 12, generate, determine, and/or provide one or more generated animated images 18 that may be incorporated into link note content 20 the user is currently creating. Thus, in some implementations, the content generation system 10 can include an animation model 14 that is operable to determine semantics relating to the user-generated content data 10 and generate, from source video 16, one or more generated animated images 18 relevant to the user-generated content data 12 that may be incorporated into the link note content 20.

In particular, the content generation system 10 can obtain user-generated content data 12. The user-generated content data 12 can include user input in a variety of formats. For instance, the user-generated content data can include user input text, image, audio, video, and/or multimodal input. Additionally and/or alternatively, the user-generated content data 12 can include transcription data, and/or user uploaded file data such as text files, audio files, image files, and/or video files. In some implementations, the user-generated content data 12 can be obtained through user input to a remote hosted web service, such as a website input field or cloud-based input processing platform (e.g., a cloud document service system, a cloud slide deck service system, a cloud cell-based document service system, etc.). Additionally, and/or alternatively, the user-generated content data 12 can be obtained through local device user input, such as a local device keyboard app, 3^{rd}-party keyboard extension, or similar local device input buffer or field.

An animation model 14 (e.g., image generation model, video generation model, frame generation model, or similar generation model) can process the user-generated content data 12 to generate one or more animated images 18. The animation model 14 can include one or more models, such as a text-to-image model, a language model (e.g., a large language model, a vision language model, and/or other language models), and/or another type of generative model (e.g., text generation model, image generation model, video generation model, frame generation model, etc.). In addition to, and/or in place of, the user-generated content data 12, the animation model 14 may process video data 16 as input to generate the one or more animated images 18. For instance, based on the user-generated content data 12, the animation model 14 may determine video data 16 to generate one or more animated images 18. More specifically, as an example, a user can provide user-generated content data 12 that is descriptive of a movie that has recently been released. The animation model may retrieve video data 16 descriptive of the movie and generate one or more animated images 18 based on processing the video data 16. The one or more animated images 18 may include a subset of the frames from the movie (e.g., video data 16) relevant to the user-generated content data 12. The one or more animated images 18 generated by the animation model 14 may be a variety of formats that support and may encode short form video content. For instance, the one or more animated images 18 may be in traditional video formats (e.g., .MP4, .MOV, .WMV, .AVI, .WebM, and/or another file format, as well as dedicated short animation formats, which may include .GIF).

The one or more animated images 18 may be provided to the user for incorporation into the link note content 20 associated with the user-generated content data 12. The one or more animated images 18 may be provided to the user via an input entry interface to incorporate into the link note content 20. A user can interact with the input entry interface to generate link note content 20 that can be transmitted to a server computing system (e.g., a search engine computing system). The link note content 20 can include text data, image data, audio data, video data, latent encoding data, and/or multimodal data. The link note content 20 can be descriptive of a note on a web resource (e.g., a link note). The note can be descriptive of commentary, an opinion, a review, a verification, and/or an indication of quality and/or topic. The link note content 20 can include the note displayed in a graphical card with one or more animated images 18, one or more widgets, one or more links, one or more media content items, and/or a graphical background.

In some implementations, the content generation system 10 can index the link note with a web resource associated with the link note content 12. The indexing can be leveraged to provide the link note content 20 including the link note for display when providing a search result for the web resource. Alternatively and/or additionally, the link note content 20 can be stored in a note database to be displayed in a notes interface when selected by one or more users. Additionally, in some implementations, the one or more animated images 18 may be stored in a database to be retrieved and utilized for later user-generated content data 12 from both the same user and others.

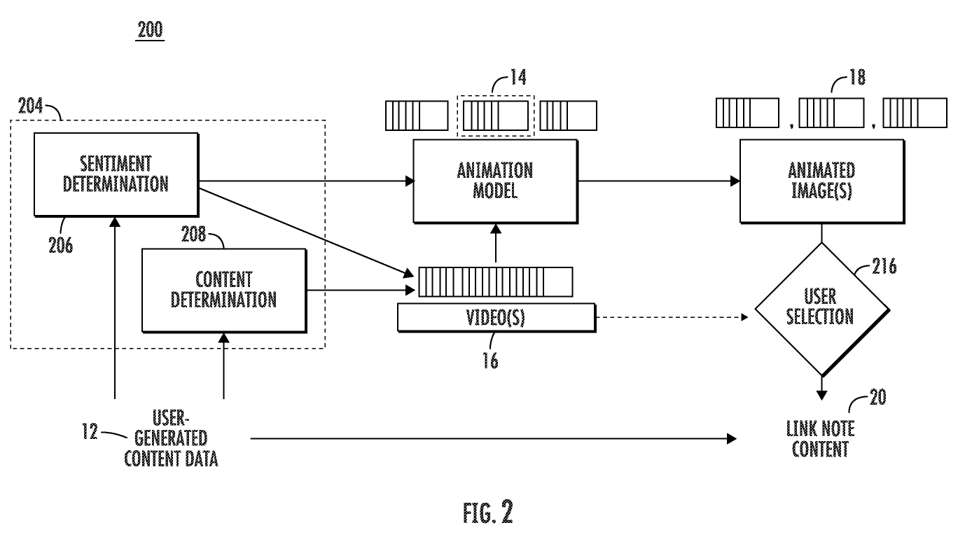

FIG. 2 depicts a block diagram of an example content generation system 200 according to example embodiments of the present disclosure. The content generation system 200 is similar to content generation system 10 of FIG. 1 except that content generation system 200 further includes sentiment determination 206 and content determination 208 which may be performed by one or more machine-learned models 204 prior to generating the one or more animated images 18. In some implementations, the one or more machine-learned models 204 may be the animation model 14. Additionally, the content generation system 200 includes the user selection 216 of one or more animated images 18 to incorporate in the link note content 20.

As previously discussed, the user-generated content data 12 can be provided to the content generation system 200 through a variety of different mediums. For instance, the user-generated content data may be provided via a remote input processing system, such as cloud-based word processors, messaging systems, and/or another similar processing system. Alternatively, and/or additionally, the user-generated content data 12 may be received through on-device input retrieval programs, such as native keyboards, or third-party keyboard plug-ins. In addition to text input, the user-generated content data 12 may include user uploaded files (e.g., image files, audio files, video files, and/or other data files) and/or newly created image data, video data, audio data, and/or similar cached within the input processing program. Additionally, and/or alternatively, the user-generated content data 12 may include specific subcategories of general data types listed herein, such as hyperlink textual data, and/or transcription audio data.

The one or more machine-learned models 204 may process the user-generated content data 12 and may perform sentiment determination 206 and/or content determination 208 to determine video(s) 16 relevant to the user-generated content data 12. The sentiment determination 206 can determine intents and/or emotions associated with the user-generated content data 12. For instance, the sentiment determination 206 may determine the user-generated content data 12 is related to excitement, happiness, and/or is asking a question. The determined sentiments may be passed (or transmitted) to the animation model 14 to generate one or more animated images 18 indicative of the sentiment determination. Referring back to the example, the animation model 14 may generate one or more animated images 18 that are indicative of excitement, happiness, and/or a question. Additionally, in some implementations, the sentiment determination 206 may be used in determining videos 16 to provide to the animation model 14. The sentiments present in the user-generated content data 12 may be leveraged in determining relevant source video to provide to the animation model 14

The content determination 208 can determine videos 16 relevant to the user-generated content data 12. For instance, as an example, the user-generated content data 12 may refer to a movie, specifically a particular scene within a movie. From the user-generated content data 12, the content determination 208 may determine the user-generated content data 12 is referring to the movie and may retrieve the referenced movie as video 16. In some implementations, the content determination 208 may determine the user-generated content data 12 may be used as video 16 for generating animated images 18. For instance, the user-generated content data 12 may include one or more videos or images and the content determination 208 may select the included videos and images as the videos 16 to be provided to the animation model 14. Alternatively, and/or additionally, the content determination 208 may determine videos 16, based on the included images and videos in the user-generated content data 12, to be provided to the animation model 14, without including images and videos themselves. In some implementations, the user-generated content data 12 may include one or more hyperlinks. The content determination 208 may select various data from the web pages associated with the one or more hyperlinks as videos 16 to provide to the animation model 14. For instance, the user-generated content data 12 may include a hyperlink to a website with several images on it. The content determination 208 may select the several images as videos 16 to provide to the animation model 14. In some implementations, videos 16 selected by the content determination 208, and/or sentiment determination 206, may be provided directly to the user via user selection 216. The content determination 208 may evaluate already existing animated images, for instance animated images stored in a repository or database and may determine one or more already existing animated images best relate to the user-generated content data 12. Alternatively, and/or additionally, the preexisting animated images may be provided as videos 16 to the animation model 14 to generate new animated images 18 based on the preexisting animated images.

In some implementations, the videos 16 selected during content determination 208 for the animation model 14 are excerpts from larger footage, pre-determined as generally popular or relevant. For instance, the content determination 208 may select a movie, in its entirety, as relevant to the user-generated content data 12 due to the user-generated content data 12 referencing the movie in some way. Alternatively, the content determination 208 may select one or more clips from the movie, and/or the movie entirely, as relevant to the user-generated content data 12 based on the sentiment determination 206. The portions of the movie provided for selection as videos 16 may be based on user interaction data with the movie. More specifically, the portions of the movie provided as videos 16 may be based on aggregated user interaction data with the movie, such as portions of the movie where users frequently skipped to, replayed, stopped watching, and/or manually created animated images during previous instances. As an example, the content determination 208 may select a particular movie as the videos 16 to be provided to the animation model 14. Rather than retrieving the entire movie as videos 16 to input to the animation model, the retrieved videos may be portions of the movie that are relevant and/or popular based on user interaction data with the movie.

The animation model 14 may generate one or more animated images 18 based on the videos 16 and sentiment determination 206 associated with the user-generated content data 12. More specifically, in some implementations, the animation model 14 may generate one or more animated images 18 from the frames of the videos 16 provided thereto based on the sentiment determination 206. The animation model 14 may determine a collection of frames from the videos 16 relevant to the sentiment determination 206 and user-generated content data 12 and may generate animated images from that collection of frames. Additionally, in some implementations, the animation model 14 may generate additional graphics or overlays within the frames of the videos 16 and generate the animated images 18 using the new augmented frames from the videos 16. For instance, the videos 16 may include several frames from a particular scene in a movie, and the sentiment determination 206 may indicate the user-generated content data 12 is directed toward a question. Therefore, the animation model 14 may augment the frames from the movie to incorporate a question mark graphic and create one or more animated images 18 using the augmented frames.

Various augmentations may be performed to the videos 16 and/or the animated images 18 generated from the videos 16. As examples, the animation model 14 may enhance frames (e.g., color correction, upscaling, etc.), animate frames, add graphical overlays, text, or audio. In some implementations where transcript data has been received as user-generated content data, the transcript data may be added to one or more frames of the videos 16 as a graphical overlay. For instance, the transcript data may be provided as a caption to one or more frames of the videos 16. Additionally, in some implementations, the animation model 14 may augment frames to remove personally identifiable data. As examples, the animation model may distort location deterministic text, blur faces, or even replace certain image data with completely new or different data (e.g., replace all faces in a frame with generated faces). For instance, the videos 16 may be user videos directly uploaded to the user-generated content data 12. The videos 16 may include one or more frames that show the front of the user’s home and their street address. Accordingly, the animation model 14 can distort the front of the house, such as changing colors, and blur the street address, or replace or remove it entirely. In some implementations, the content generation system 200 may augment the frames of the animated images 18 to remove sensitive content, which may include personally identifiable data, gore, vulgarity, and/or other sensitive content. The augmentation may include leveraging an image generation model (e.g., a text-to-image diffusion model) to generate replacement pixels for portions of the frames that include the sensitive content.

Alternatively, and/or additionally, the animation model 14 may generate completely new animations by generating frames based on the videos 16 and sentiment determination 204. For instance, the animation model 14 may include one or more machine-learned image generation models (e.g., text-to-image diffusion models) that may generate one or more frames to be used by the animation model 14 in generating the animated images 18. Additionally, in some implementations, the one or more machine-learned models 204, such as the animation model 14, may utilize the user-generated content data 12 to generate prompts for one or more text-to-image generation models whose output may be used as one or more frames in the animated images 18. In this manner, the animation model 14 (e.g., machine-learned models 204) may generate animated images 18 without the use of videos 16.

The animation model 14 may perform the animation generation process according to user preferences, video-provider preferences, and/or device restrictions. For instance, the user may have preferences to only use pre-existing footage for GIF curation (e.g., no image generation content) and therefore the animation model 14 will only generate animated images 18 using pre-existing video. Conversely, the user may have a preference to only use image generation content and, therefore, the animation model 14 may only produce GIFs using image generation models and techniques. Additionally, in some implementations, the methods and execution of the animation model 14 may vary based on user device restrictions. For instance, if the user-generated content data 12 is being retrieved from a device capable of supporting the processing load of the animation model 14, the animated images 18 may be generated local to the user device. Conversely, the animated images 18 may be generated remotely. For example, the content generation system 200 may determine the user device is without the computing resources to host the animation model 14 processing; therefore, the content generation system 200 may perform the animated image 18 generation via a server computing system. In some implementations, the videos 16 may be reduced in size via trimming length, changing encodings, and/or downscaling to achieve latency restrictions of the user device, and/or user preferences. Additionally, across all implementations, the animation generation process may be performed several times over to generate a plurality of animated images 18 varying in length, quality, augmentations, and/or content to provide the user with a diverse range of options for selection.

Once generated, the animated images 18 may be presented to the user in a link notes interface for user selection 216. The user selection 216 may present a plurality of the animated images 18 to the user with the option to incorporate the animated images 18 into the link note content 20. For instance, a user may select one of the animated images 18 to be displayed within the link note content 20 and, once selected, the image may appear within the link note content 20 with a new animated image replacing the selected one within the user selection 216. Additionally, in some implementations, the animated images 18 presented to the user within user selection 216 may be sent to an image repository for later use. Once a user has selected an animated image of the animated images 18 to be incorporated in the link note content 20, the selected animated image may be stored along with the user-generated content data 12 in the link note content with an associated web link. When the associated web link is returned for a query, the link note content, and subsequently the selected animated image, may be presented for display.

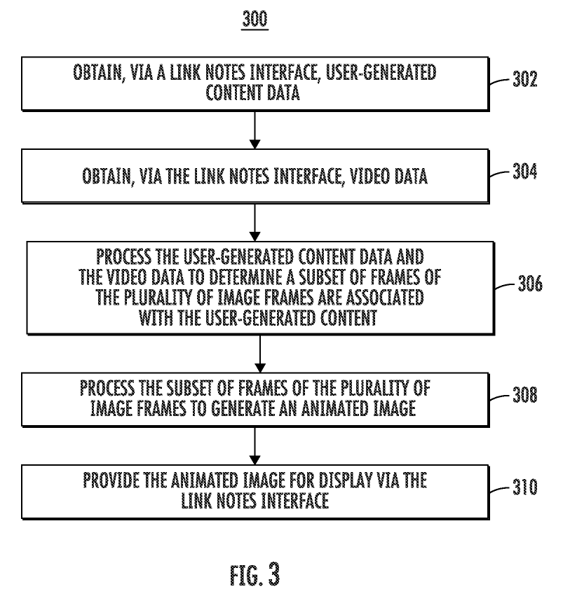

FIG. 3 depicts a flow chart diagram of an example method to perform according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing system can obtain, via a link notes interface, user-generated content data. The user-generated content data can include a text string input by a user. The link notes interface can include a user interface that is configured to receive inputs to generate user generated link notes to index with web resources. In some implementations, obtaining the user-generated content data includes receiving the text string input with a freeform input box provided by the link notes interface.

At 304, the computing system can obtain, via a link notes interface, video data. The video data can be a plurality of image frames and audio data. The link notes interface can include a user interface that is configured to receive inputs to generate user generated link notes to index with web resources. The link notes interface can be a GUI with a plurality of user interactable elements. For instance, the link notes interface can be a GUI with a user created link note card, the link note card being associated with one or more web resources. In some implementations, the link note card can be indexed with a web resource to be retrieved when the web resource is requested. Additionally, in some implementations, the link note card can include one or more text boxes and one or more graphical elements selected by the user. The user may edit, resize, or otherwise modify the one or more text boxes and graphical elements within the link note card via the link notes interface.

The video data can be obtained from a variety of sources in a variety of formats and can include a plurality of image frames. In some implementations, the video data can be provided by the user within user generated content data. Additionally, and/or alternatively, the video data can be obtained from a plurality of online resources or databases. For instance, the computing system can determine a portion of video data relevant to the user generated content data and retrieve the portion of video data from an online database.

At 306, the computing system can process the user-generated content data and the video data to determine a subset of frames of the plurality of image frames are associated with the user-generated content. In some implementations, determining the subset of frames associated with the user-generated content data includes processing the audio data with a transcription model to generate a transcript for the video data. The transcript and the text string may be input to a machine-learned language model to determine the subset of frames of the plurality of image frames.

At 308, the computing system can process the subset of frames of the plurality of image frames to generate an animated image. The animated image can be an animated playback of the subset of frames ordered sequentially. Additionally, and/or alternatively, the animated image can be configured in a graphics interchange format. A selection of the animated image can be obtained, and a link note can be augmented to include the animated image and the text string input, based on the selection of the animated image.

In some implementations, generating the animated image can include processing the audio data to transcribe at least a portion of the audio data associated with the subset of frames to generate a partial transcript. The partial transcript can then be rendered over the subset of frames.

At 310, the computing system can provide the animated image for display via the link notes interface. Providing the animated image for display includes providing the animated image for display within the freeform input box adjacent to the text string input. In some implementations, a graphical card may be generated based on the test string input and the animate image. The graphical card can include a stylized format of the text string input and the animated image. Additionally, in some implementations, the graphical card may be indexed with resource data associated with a particular web resource. In some implementations, a search query may be obtained, and the particular web resource may be determined to be responsive to the search query. Therefore, a search results interface may be generated that can include a title for the particular web resource, a text snipped from the particular web resource, a hyperlink to access the particular web resource, and the graphical card. While several additional steps are discussed herein in succession, it should be appreciated that the methods discussed with respect to FIG. 3 may be performed with any combination of steps and in any order. The steps of method 300 and its additional possible implementations are not limited to the orders discussed, rather these orders are for illustrative purposes to provide example implementations of the present disclosure.

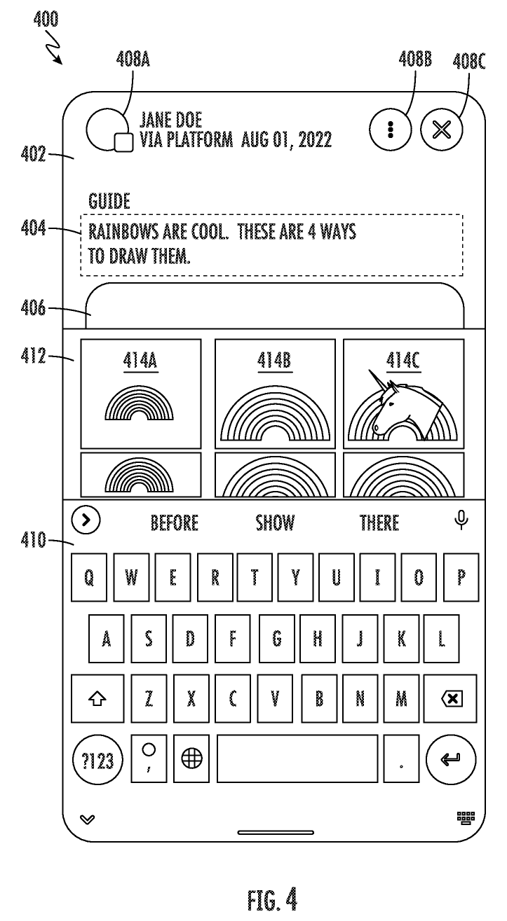

FIG. 4 depicts an example embodiment of a link notes interface 400 according to example embodiments of the present disclosure. The link notes interface 400 may be displayed for a user to interact with on a variety of computing systems and devices, such as, for instance, mobile computing devices. The link notes interface 400 may provide a graphical interface for a user to compose a link note and generate a graphical link note card 402.

The link notes interface may include a graphical link note card 402 that may include several different user interface elements and graphics. More specifically, the link note card 402 may include one or more text boxes 404, one or more graphical content items 406 and one or more other user interface elements 408. The one or more text boxes 404 and graphical content items 406 may be selected and included within the link note card 402 via user selection. The text boxes 404 and graphical content items 406 may be placed anywhere within the card 402 and sized based on user selection and/or may be automatically sized based on card semantics, card layout, and/or other feature determinations. The other user interface elements 408 may be overlayed onto the link note card 402 via the hosting computing system for user management of the link note card 402. Additionally and/or alternatively, the other user interface elements 408 may be provided with the graphical link note card 402 to provide additional details and/or interactivity options associated with the graphical link note card 402. The other user interface elements 408 may include a profile indicator 408A associated with the user who composed the link note, an options user interface element 408B that is selectable to open an actions menu, and/or a close user interface element 408C selectable to close the graphical link note card 402.

In some implementations, the one or more text boxes 404 and graphical content items 406 may be edited and/or modified via the user input interface 410. The user input interface 410 may support a variety of user input types such as audio, video, text, image, and/or multimodal input. In the example embodiment provided in FIG. 4, the user input interface 410 includes a keyboard allowing for user text input. In some implementations, the user input interface 410 may include the animated image library overlay 412 with one or more animated images 414 (e.g., a first rainbows animated image 414A, a second rainbows animated image 414B, a unicorn and rainbows animated image 414C, and/or one or more other media content items). The animated image library overlay 412 may allow for user input to select one or more of the animated images 414 and insert the selected one or more animated images 414 into the link note card 402. In some implementations, the one or more animated images 414 may be inserted into the link note card 402 based on and/or via the one or more text boxes 404 and/or graphical content items 406.

In some implementations, the one or more animated images 414 may be, for instance, the one or more animated images 18 discussed in FIG. 2 and incorporated by reference herein. As previously discussed, the animated images 18 may be generated based on user-generated content data. As an example, the one or more animated images 414 may be the animated images 18 generated based on user generated content data, the user generated content data being within the one or more text boxes 404 and/or provided via the user input interface 410. Additionally, and/or alternatively, the one or more animated images 414 may be generated based on user-generated content data within the one or more graphical content items 406. In some implementations the animated images 414 may be generated based on determined topics within the user generated content data (e.g., within the one or more text boxes 404 and/or graphical content items 406).

The link note card 402 can include, based on user input and selection, one or more of the animated images 414 and be indexed with a web resource for future retrieval. In this way, when the web resources are requested for query satisfaction, the graphical link note card 402 may be provided in response to the query along with the requested web resources. In particular, the graphical link note card 402 may be provided adjacent to a respective web resource associated with the particular link note.

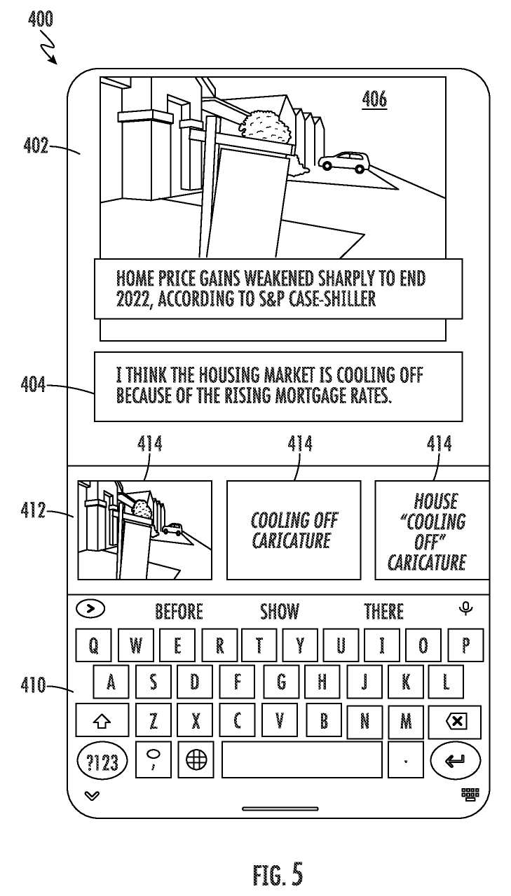

FIG. 5 depicts another example embodiment of a link notes interface 400 according to example embodiments of the present disclosure. In some implementations, the link notes interface 400 may include one or more graphical content items 406 that can include a hyperlink functionality. In this manner, the graphical content items 406 can act as user interface elements wherein a user may select the graphical content items 406 and be redirected to a web resource. Additionally, in some implementations, the one or more animated images 414 may be generated based on the web resource associated with the graphical content items 406. For instance, the animated image library overlay 412 may provide one or more animated images 414 for user selection based on the web resource associated with the graphical content items 406. The user may then select, via the user input interface 410 and animated image library overlay 412 one or more of the animated images 416 to include in the link note card 402. Additionally, and/or alternatively, the animated images 414 may be generated based on one or more sentiments determined within user generated content data within the graphical link note card 402 such as, for instance, the one or more text boxes 404.

In some implementations, the animated image library overlay 412 and one or more animated images 414 may appear, along with the user input interface 410, without the presence of the link notes interface 400 or link note card 402. In this manner, the animated images 414 may be selected and provided within any number of systems and/or applications where the user input interface 410 is requested or provided. The animated images 414 may be generated based on any user-generated content data provided to the user input interface 410, not necessarily present within the link notes interface 400 or link note card 402.

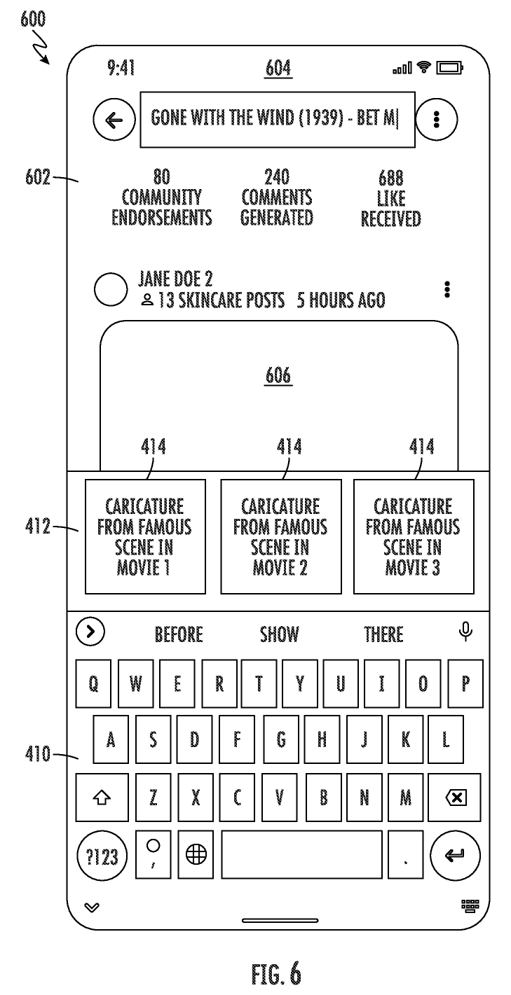

FIG. 6 depicts an example system display 600 according to example embodiments of the present disclosure. The display may be programmed to display one or more graphical applications 602, the graphical applications 602 requesting for display, and providing for, the user input interface 410. The user input interface 410 may provide user-generated content data to the one or more graphical applications 602. For instance, the user input interface 410 can provide user-generated content data to one or more text boxes 604 within the graphical applications 602. Additionally, the user input interface 410 may provide the animated image library overlay 412 with one or more animated images 414 for user input and selection. The user input interface 410 may then insert a user selection of the one or more animated images 414 into the graphical applications 602, such as in the one or more text boxes 604.

In some implementations, the one or more animated images 414 may be generated based on user-generated content data within the graphical applications 602, as well as, any content within the graphical applications 602, such as the one or more graphical elements 606 and/or text boxes 604. For instance, the animated images 414 may be generated based on user-generated content data and/or content data within the one or more text boxes 604 and graphical elements 606. As depicted in FIG. 6, the one or more animated images 414 may be generated based on the user generated content data within the one or more text boxes 604. In some implementations, the animated images 414 are generated based on a video determined from the user-generated content data, such as the user-generated content data within the text boxes 604.

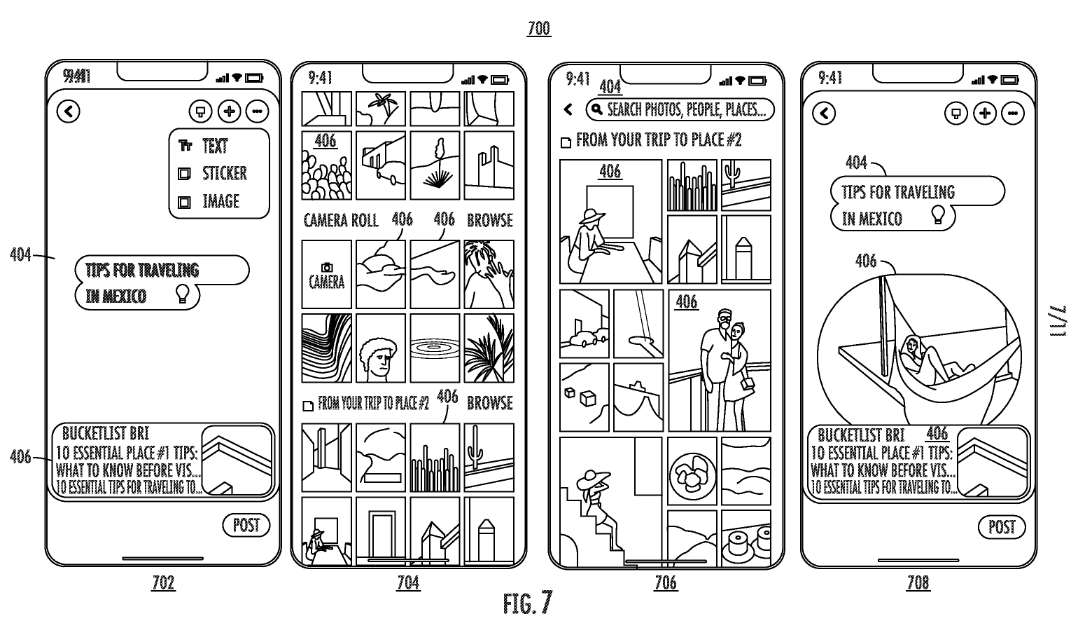

FIG. 7 depicts an illustration 700 of example link notes interfaces according to example embodiments of the present disclosure. In particular, the illustration 700 provides a variety of potential link notes interfaces a user can interact with and animated images can be generated for and from to generate graphical link notes cards. For instance, one or more animated images can be generated based on card data, context data, and/or user-generated content data within the various link notes interfaces of the illustration 700.

For example, at 702, a graphical card is provided for display with an option to insert additional text, a sticker, and/or an image. One or more animated images may be generated for insertion and/or display via any of the one or more text boxes 404 or graphical content items 406 (e.g., static images, animated images, and/or videos) present within the link notes interface. At 704, another link notes interface can be provided for display, which can include default images, camera roll images, and/or image suggestions based on the text of the graphical card, the contents of the web resource associated with the link note, a user history, and/or other data. For example, a plurality of images from the user’s image gallery may be determined to be relevant to the text of the graphical card based on determining the images are associated with a location (e.g., Mexico) that was referenced in the text of the graphical card. The various images provided within the link notes interface shown at 704 can be used to generate one or more animated images. Additionally, and/or alternatively, the various images depicted at 704 can be used within, or entirely as, the generated one or more animated images. At 706, another link notes interface can be provided for display and used to generate one or more animated images. In some implementations, the selected images displayed at 706 can be alongside one or more animated images generated with and/or based on the selected images. A user may select a particular image from the identified images, which may be processed and inserted into the graphical card. In some implementations, the particular image inserted into the graphical card may be one or more generated animated images. At 708, the selected image may be cropped and inserted into the graphical card for display. In some implementations the selected image may be one or more generated animated images. The animated images generated in accordance with aspects of the present disclosure. For instance the generated animated images discussed with reference to FIG. 7 may be the animated images 18 discussed in FIG. 2.

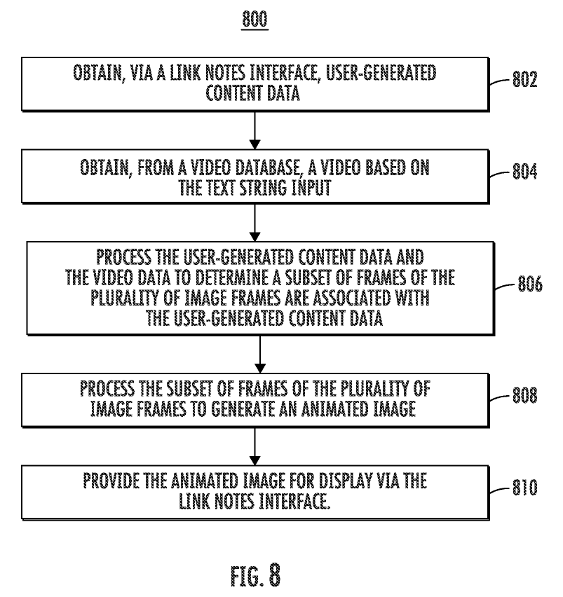

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain, via a link notes interface, user-generated content data. The computing system can include one or more processors and the user-generated content data can include a text string by the user. The link notes interface can include a user interface that is configured to receive inputs to generate user generated link notes to index with web resources. The link notes interface can be a GUI with a plurality of user interactable elements. For instance, the link notes interface can be a GUI with a user created link note card, the link note card being associated with one or more web resources. In some implementations, the link note card can be indexed with a web resource to be retrieved when the web resource is requested. Additionally and/or alternatively, the link note card can include one or more text boxes and one or more graphical elements selected by the user. The user may edit, resize, and/or otherwise modify the one or more text boxes and graphical elements within the link note card via the link notes interface.

At 804, the computing system can obtain, from a video database, a video based on the text string input. The video can include a plurality of image frames and audio data, and the video database can include a plurality of different videos. In some implementations, the video database can include a user-specific video database that stores videos saved by the user. Additionally and/or alternatively, the video database can include a historical log of videos recently viewed by the user.

At 806, the computing system can process the user-generated content data and the video to determine a subset of frames of the plurality of image frames are associated with the user-generated content data. In some implementations, processing the user-generated content data can include determining a particular sentiment, action, or topic of the text string input within the user-generated content. Additionally, and/or alternatively, in some implementations, processing the user-generated content can include determining the subset of frames of the plurality of image frames are associated with the particular sentiment, topic, and/or action, respectively.

At 808, the computing system can process the subset of frames of the plurality of image frames to generate an animated image. For example, an animated image can be rendered based on saving the subset of frames in an animated image format sequentially, such that the subset of frames may be sequentially displayed by the animated image.

At 810, the computing system can provide the animated image for display via the link notes interface. For example, the animated image may be provided in a dynamic keyboard interface, which may include displaying the animated image with a plurality of other animated images in a carousel interface.

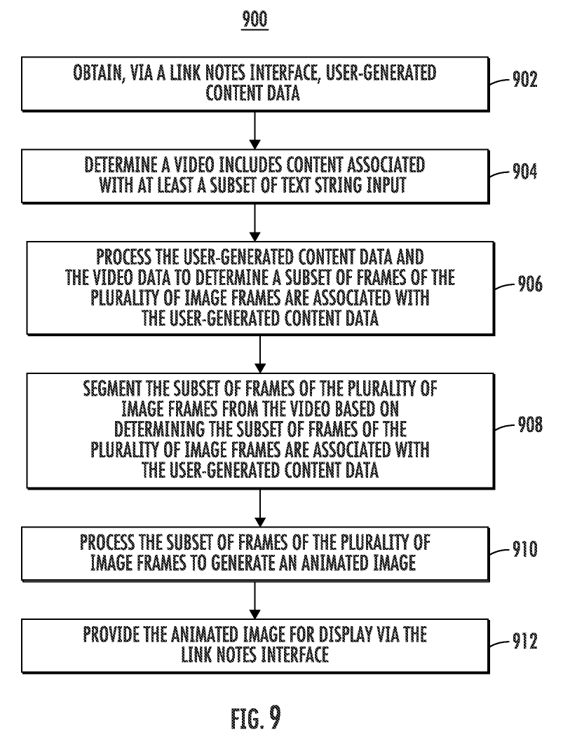

FIG. 9 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 900 can be omitted, rearranged, combined, and/or adapted in various ways without deviating from the scope of the present disclosure.

At 902, a computing system can obtain, via a link notes interface, user-generated content data. The user-generated content data can include a text string input by a user and the link notes interface can include a user interface that is configured to receive inputs to generate user generated link notes to index web resources. The link notes interface can be a GUI with a plurality of user interactable elements. For instance, the link notes interface can be a GUI with a user created link note card, the link note card being associated with one or more web resources. Additionally, in some implementations, the link note card can include one or more text boxes and one or more graphical elements selected by the user. The user may edit, resize, or otherwise modify the one or more text boxes and/or one or more graphical elements within the link note card via the link notes interface.

At 904, the computing system can determine a video includes content associated with at least a subset of text string input. The video data can include a plurality of image frames and audio data. The audio data can be descriptive of speech data associated with dialogue within the video.

At 906, the computing system can process the user-generated content data and the video to determine a subset of frames of the plurality of image frames are associated with the user-generated content data. The subset of frames may be determined based on obtaining and/or generating a video transcript and performing a keyword and/or entity search on the transcript based on the user-generated content data text. Alternatively and/or additionally, the subset of frames may be determined based on feature recognition. For example, the text of the user-generated content data may be associated with the topic of elephants, and the plurality of frames of the video can be processed with a detection model to determine the subset of the frames that depict an elephant.

At 908, the computing system can segment the subset of frames of the plurality of image frames from the video based on determining the subset of frames of the plurality of image frames are associated with the user-generated content data. The segmentation may include segmenting a plurality of subset then stitching the plurality of subset before generating the animated image.

At 910, the computing system can process the subset of frames of the plurality of image frames to generate an animated image. The animated image can include an animated playback of the subset of frames ordered sequentially. In some implementations, processing the subset of frames can include processing at least a subset of the text string input with a text-to-image generation model to generate one or more model-generated images, wherein the one or more model-generated images comprise a plurality of predicted pixels generated based on the text string input. Further, in some implementations, the animated image can be generated based on the subset of frames and the one or more model generated images. In some implementations, the text-to-image generation model can include a diffusion model. In some implementations, the animated image can include one or more model-generated images interweaved within the subset of frames of the plurality of image frames.

At 912, the computing system can provide the animated image for display via the link notes interface. The animated image may be provided as a suggestion, which may include depicting the animated image within a suggested region of the graphical link note card. In some implementations, the animated image may be provided in a selectable pop-up user interface element.

In some implementations, the systems and methods disclosed herein can determine and/or leverage video anchors. The video anchors can be descriptive of times within a video that are associated with particular moments. The particular moments can be associated with semantic scenes, chapters, exchanges, etc. The systems and methods can expose, by use of video timed anchors, different parts of a video. Each part of the video corresponding to a video anchor may begin at a “key moment.” The video anchors may allow users to quickly ascertain important points in the video, giving them a better sense of the video itself and may allow users to directly skip to a point in the video, saving them time.

A video timed anchor processing system can process videos to generate video anchors for each of the videos. In operation, a system can obtain, for a video, a plurality of key moment identifiers. The key moment identifiers may be determined algorithmically, such as by a trained neural network, or may be provided by a human curator. Each key moment identifier may include a time index value specifying a playback time in the video and can be indicative subject matter of the video that has been determined to meet one or more interest criteria that define salient topics within the video.

For each key moment identifier, the system may select a proper subset of the video beginning at the playback time specified by the time index value. The proper subset of the video can be a portion of the video that is less than a length of a video segment beginning at the playback time specified by the time index value and ending at a next most recent playback time specified by another time index value of another key moment identifier. For example, if a first key moment identifier indicates a playback time of 1:00, and the next key moment identifier indicates a playback time of 2:30, the proper subset of the video may begin at 1:00 and may end before 2:30.

The system can determine, for the proper subset of the video, a textual label for the key moment identifier. The textual label can be determined by one or more of textual signals, visual signals, and manual curations. Textual signals can include optical character recognition, caption data, and video meta data. Visual signals can include embeddings, audio, and image label generation. Manual curations can include manually generated annotations.

The system can process each video frame of the proper subset of the video to determine whether to select a video frame from the proper subset of the video, and can then generate, for each key moment identifier, a video anchor. Each video anchor can include the textual label for the key moment identifier, and, if a video frame was selected, the video frame. Each video anchor may include an instruction that causes a video player on a user device to begin playback of the video at the playback time specified by the time index value of the key moment identifier.

The data defining the video anchors can then be stored in an index and associated with the video to which the data corresponds. The data can cause a user device to render, in a video player environment of the user device, each of the video anchors. The data can then be served to user devices that request the video, along with the video itself. The system can provide, to a user device, the data in response to a video request. For each video anchor, the user device can display a corresponding time indicator in a progress bar of the video player, and a visual link from the corresponding time indicator to the visual anchor. Each displayed video anchor can be selectable by a user and upon a selection of the video anchor the instruction of the video anchor can cause the video player on a user device to begin playback of the video at the playback time specified by the time index value.

Additionally and/or alternatively, the present disclosure can be directed to systems and methods for moment localization in a video corpus using representations from hierarchical video encoders. Conceptually, a video can be represented as a sequence of (e.g., fixed length) video segments or “clips” which, intuitively, serve as memory units representing the semantics of one or more frames in the video segment. Each video segment can be a nonoverlapping set of one or more frames of a larger video. A “frame” with respect to a video may refer to audio, visual, and/or captioning/transcript data associated with a (e.g., smallest) temporal slice of the video. For instance, a video may be composed of at least a (e.g., temporally linear) sequence of frames, where each frame includes an image, a portion of a stream of audio data to be played along with the sequence of images, and/or supplementary text (e.g., captioning) to be displayed along with the sequence of images.

Additionally and/or alternatively, the systems and methods disclosed herein may leverage hierarchical video encoders for encoding videos to generate representations that may be leveraged for the video search, the video segmentation, and/or other video understanding/processing tasks. The hierarchical video encoders can include a hierarchy of two (or more) encoder models, such as Transformers (e.g., cross-attentional transformers). A lower-level intrasegment encoder (also referred to as a frame-level encoder) may encode frame-level information of video data (e.g., video frames or representations thereof) into frame representations. Segment representations for video segments can be determined based on these frame representations, such as by providing a context token for a given video segment based on the frame representations of frames in that video segment. A higher-level intersegment encoder (also referred to as a segment-level encoder) encodes the segment representations into contextualized segment representations, which can further be used to produce a video representation. For instance, in some implementations, the hierarchical video encoder model can include a frame-level encoder model configured to receive a plurality of frames of a video as input and provide, in response to receipt of the plurality of frames as input, a plurality of frame representations of the plurality of frames as output. Additionally and/or alternatively, the hierarchical video encoder model can include a segment-level encoder model configured to receive a plurality of segment representations as input and provide, in response to receipt of the plurality of segment representations as input, a plurality of contextualized segment representations as output.

In some implementations, the frame-level encoder model and/or the segment-level encoder model can be a multimodal encoder configured to produce a plurality of representations based at least in part on associated text. For instance, in addition to encoding the video data and/or representations thereof, the encoder(s) (e.g., the lower-level encoder and/or the higher level encoder) can be cross-modal encoders that additionally fuse the video data and/or representations thereof with associated text data, such as, for example, captioning data for the video and/or query data descriptive of a user query representing a user's search for videos and/or, more particularly, content depicted within the videos. For instance, in the encoder(s), the input modality pairs can have cross attention, such as visual-caption/transcript, visual-query, and/or transcript-query attention. In some implementations, the associated text can be encoded (e.g., by a text encoder model, such as a text transformer).

A lower-level cross-attentional encoder can receive as input a frame sequence of a video segment and the query and output, in response, contextualized frame-level features for each video segment. A segment representation of the frames of each video segment can be determined for each video segment based on the frame-level features in the segment. As one example, the segment representation can include a context token (e.g., a visual CLS frame) associated with a video segment. These segment representations for each video segment can be input (e.g., as a sequence and/or in addition to the query) to a higher-level cross-attention encoder. The higher-level encoder can output, in response, contextualized segment level features. In this way, the hierarchical video encoder may learn the segment representations using local (intra-segment) self- and/or cross-attention among the frames belonging to the same video segment by the lower-level encoder, while the high-level encoder learns the video representation using global (inter-segment) self- and cross-attention among the video segments of the video.

In some implementations, the machine-learned frame-level encoder model and the machine-learned segment-level encoder model can include one or more shared parameters. For instance, in some implementations, the models may be separately utilized but have some or all common parameters between the models such that the models are similar or identical. In some implementations, each model can have entirely unique parameters.

For instance, the hierarchical video encoder models can be employed in a computer-implemented method for generating video representations. The method can include obtaining (e.g., by a computing system including one or more computing devices) a video. The video may include a plurality of frames. Each frame can include visual data (e.g., an image) and/or associated audio data (e.g., a slice of an audio stream). The video may be unsegmented, such that no temporal divisions exist in the video. The video may be, for example, accessed from a corpus of videos, such as a content sharing website, media provider, database, and/or other suitable corpus.

Additionally and/or alternatively, the method can include processing (e.g., by the computing system) each of the plurality of frames with a machine-learned frame-level encoder model to respectively generate a plurality of frame representations for the plurality of frames. The plurality of frame representations can be respective to the plurality of frames. For instance, each frame representation can be produced from a respective (e.g., unique) frame of the plurality of frames.

In some implementations, the frame-level encoder model can be a multimodal encoder model configured to produce the plurality of frame representations based at least in part on associated text (e.g., a user query, captioning for the video, etc.). For instance, the method can include processing (e.g., by the computing system) the associated text with the machine-learned frame-level encoder model to produce the plurality of frame representations. The plurality of frame representations can be based at least in part on the associated text. The associated text can be processed concurrently with the plurality of frames. In some implementations, the associated text can be encoded.

Additionally and/or alternatively, the method can include determining (e.g., by the computing system) a plurality of segment representations representative of a plurality of video segments including one or more of the plurality of frames. In some implementations, the plurality of video segments can each have about equal length. For instance, in some implementations, a video may be divided into video segments based at least in part on a fixed segment length. In some implementations, the plurality of video segments may be nonoverlapping. For instance, a given frame may be included within only one video segment of the plurality of video segments.

The plurality of segment representations can be based at least in part on the plurality of frame representations. In some implementations, the plurality of segment representations can include a context token. As one example, the plurality of frame representations can be, can include, or can otherwise be used to generate a contextualized frame representation, such as a context (e.g., CLS) token specific to each frame. The context tokens for each frame can be aggregated or otherwise combined to produce a segment representation for a video segment including the frames for which the context tokens are combined.

Additionally, the method can include processing (e.g., by the computing system) the plurality of segment representations with a machine-learned segment-level encoder model to generate a plurality of contextualized segment representations. The contextualized segment representation can include a context (e.g., CLS) token specific to the respective video segment. In some cases, processing the plurality of segment representations can include processing (e.g., by the computing system) the associated text with the machine-learned segment-level encoder model to produce the plurality of contextualized segment representations. The plurality of contextualized segment representations can thus be based at least in part on the associated text.

Additionally, the method can include determining (e.g., by the computing system), based at least in part on the plurality of contextualized segment representations, a video representation. For instance, in some implementations, context tokens corresponding to each segment in a video can be aggregated or otherwise combined to produce the video representation. Additionally, the method can include providing (e.g., by the computing system) the video representation as an output (e.g., of the hierarchical video encoder model).

Hierarchical video encoders as described herein can be useful in a variety of computing tasks. One example task relates to identifying and localizing a moment relevant to a user query (e.g., a text query) from a corpus of videos, which may be untrimmed and/or unsegmented. As one example, in some cases, a user query may be a single query sentence describing a relatively small portion within a larger video. For instance, a user searching in response to a user query may wish to see particular moments of a longer video in response to the user query, such as to see only segments of the video depicting content that is relevant to the query. As one example, a video titled “how to cook chicken parmesan” and depicting steps of making chicken parmesan may include a portion dedicated to a step of butterflying chicken. Thus, a user searching with a query such as “how to butterfly chicken” may desire to view the video titled “how to cook chicken parmesan” despite the apparent lack of relationship between video title and content. The user may be presented with the portion of the video (e.g., the moment) related to butterflying chicken such that the user does not have to manually search for the related content, which may not be immediately apparent to the user.

As video content available online continues to grow, it can become increasingly desirable and increasingly difficult to thoroughly manage and categorize the ever-increasing corpus of video content. For instance, to effectively and efficiently search, browse, or otherwise navigate through a corpus of videos, an intelligent system must understand rich and complex semantic information included in the videos. These videos can have a significant variation in factors such as content type, length, appearance, quality, and other factors. For instance, localizing a moment responsive to a user query can require semantic understanding of many possible segments of videos.

The systems and methods may first rank videos in a corpus of videos by relevance to a given user query. For instance, a computing system including one or more computing devices can obtain (e.g., from a user) a user query. The user query can include text (e.g., text data). The user query can be obtained in any suitable manner according to example aspects of the present disclosure. As one example, the user query can be obtained from a user by providing a user with a text field in which to enter the user query, such as at a search engine service. As another example, the user query can be obtained from an external computing system or other computing device. The user query may be or include only text data, may be or may include speech data (e.g., that is converted into text data) and/or may be or may include any other suitable data. In some cases, the user query can be or can include a short text string (e.g., on the order of fewer than about 20 words) descriptive of a moment within a video.

A number of highest ranking videos (e.g., the K highest ranking videos) can be selected such that moment localization is performed on the highest ranking videos to identify a moment relevant to the user query. For instance, a computing system can identify one or more highest likelihood videos of the plurality of videos. This task of identifying the highest ranking video(s) is referred to herein as Video Retrieval, or VR. Performing the VR task can primarily be useful in reducing computational requirements by restricting a number of videos that must be searched for moment localization.

In some implementations, each highest likelihood video of the one or more highest likelihood videos can be identified based at least in part on a video-query compatibility score between the user query and a video representation of the highest likelihood video that is output by a machine-learned hierarchical video encoder model. For instance, the video-query compatibility score can effectively rank the corpus of videos and the K highest scoring video(s) in the corpus, as defined by the video-query compatibility score, can be selected as the highest likelihood video(s). In some implementations, the video representation of a highest likelihood video can be based at least in part on a highest scoring segment representation of a plurality of segment representations of the highest likelihood video. For instance, the hierarchical video encoder may output a plurality of segment representations associated with a plurality of video segments of the highest scoring videos, each of which has an associated compatibility score with the user query. The highest score of these compatibility scores can be used as representative of the entire video. In some implementations, the one or more highest likelihood videos can be selected based at least in part on a negative log-likelihood of the one or more highest likelihood videos containing the moment described by the user query. For instance, the videos can be selected to minimize the negative log-likelihood.

A modeling objective for the video retrieval task can select a matching video most likely to have a moment to be localized by employing a contrastive loss that contrasts a compatibility score of positive (e.g., matching) pairs of video representation and query against negative (e.g., not matching) pairs of video representation and query. The negative pairs can be randomly sampled.

In some cases, the representation of a highest likelihood video can include a highest scoring segment representation of a plurality of segment representations of the highest likelihood video. For instance, of a plurality of segments of the video, the score of the highest-scoring segment can be selected as representative of the entire video. In some implementations, the one or more highest likelihood videos can be selected based at least in part on a negative log-likelihood of the one or more highest likelihood videos containing the moment described by the user query.

Once the highest ranking video(s) are selected, moment(s) within the videos related to the user query can be localized. For instance, a moment localization can be determined for a moment, where the moment localization specifies a beginning and/or an end of the moment. As one example, the moment localization can be or can include timestamps, frame indices, etc. This task can be referred to as Moment Localization in Single Video, or MLSV. The hierarchical video encoders as described herein can be jointly trained on both tasks in a multitask learning configuration. The hierarchical (e.g., and cross-attentional) encoders can be beneficial for these tasks, as the two tasks can require understanding semantics of a video at differing temporal resolutions, and the models described herein can model short-range and long-range video semantics. For instance, the hierarchical video encoders can learn semantic understanding for at least three scales: frame-level, segment-level, and/or video-level. For example, including segment-level encoders as described herein can provide for capturing both coarse- and fine-grained semantic information in videos.

Additionally and/or alternatively, one or more classifiers can be applied to identify regions (e.g., frames) corresponding to a beginning and/or an end of a relevant video segment. For instance, a lower-level classifier (e.g., a per-frame classifier) can be used to classify a probability of each frame being a starting frame and/or an ending frame. A higher-level classifier (e.g., at the segment level or video level) can classify a probability of a starting frame and/or an ending frame being located within a segment and/or video.

Moment localization can thus essentially be treated as a frame classification problem. For instance, each frame can be classified as belonging to one of three labels: a beginning frame, which marks the beginning of a moment localization; an end frame, which marks the end of a moment localization; and another frame that may or may not be included within a moment localization for a given moment but may not be bordering a moment. Additionally and/or alternatively, a loss during training of the hierarchical video encoder model can include a cross-entropy loss between a predicted classification of each frame and a true label of each frame.

The hierarchical video encoders can perform the two tasks of VR and MLSV at the temporal resolution required for the respective task. For instance, in some cases for the MLVC task, the user query is a sentence describing some fraction of the video content. Therefore, at the frame level representation, there can be a number of frames that are irrelevant to the query, resulting in low signal-to-noise ratio for the VR task. By learning segment-level representations, the encoders may learn a more coarse-grained matching between the video and the query which filters out the noise. Hence, for the VR task, it may be possible to use the learned representations only at the higher-level (e.g., video segment). The MLSV task can benefit from a fine-grained frame-level representation, providing for computing the start and end probabilities of each frame. Thus, for the MLSV task, conditional probabilities can be computed at the lower-level (frame). The hierarchical video encoding may provide for learning the two tasks of VR and MLSV simultaneously in a joint training setup while still learning the respective objectives at the desired temporal resolution.

The hierarchical video encoders can be beneficial for video search applications, such as retrieving specific segments of a longer video that are relevant to a given user query. In addition to and/or alternatively to video search applications, the hierarchical video encoders can be useful for learning topical compositions of videos. Improved knowledge of topical compositions of videos can be useful for assisting in the placement of anchor points throughout videos that may be useful, for example, for annotation placement, navigability, etc. As an example, a user can be provided with navigation options based on the topical content. The improved knowledge of topical compositions or content of videos can additionally be useful for learning annotations for semantically meaningful video segments for indexing to aid quick retrieval.

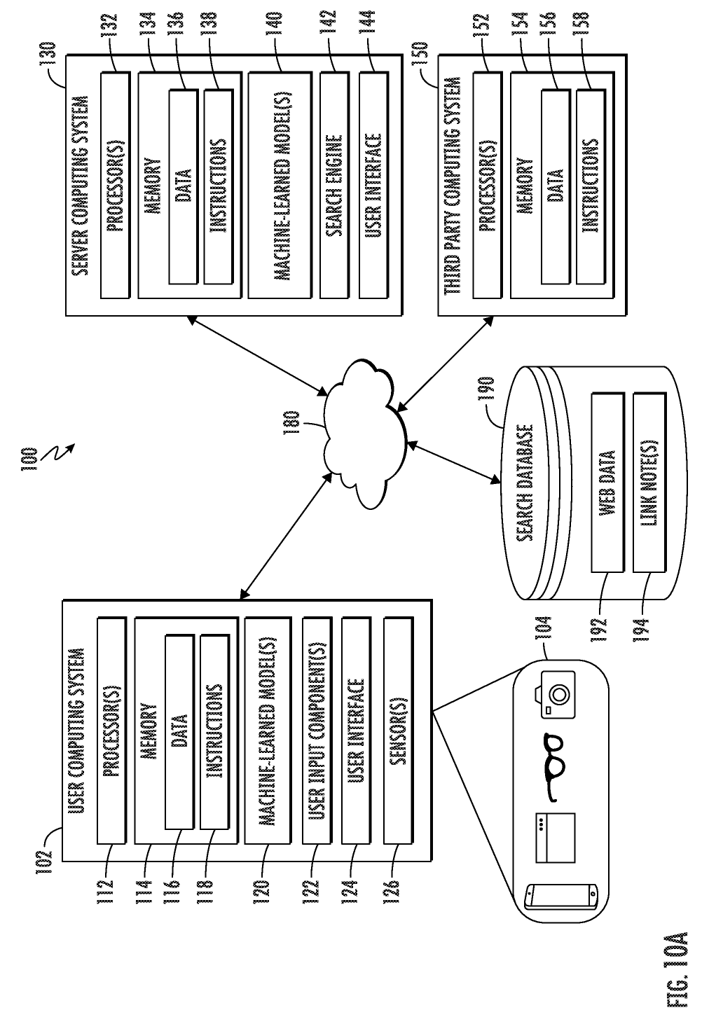

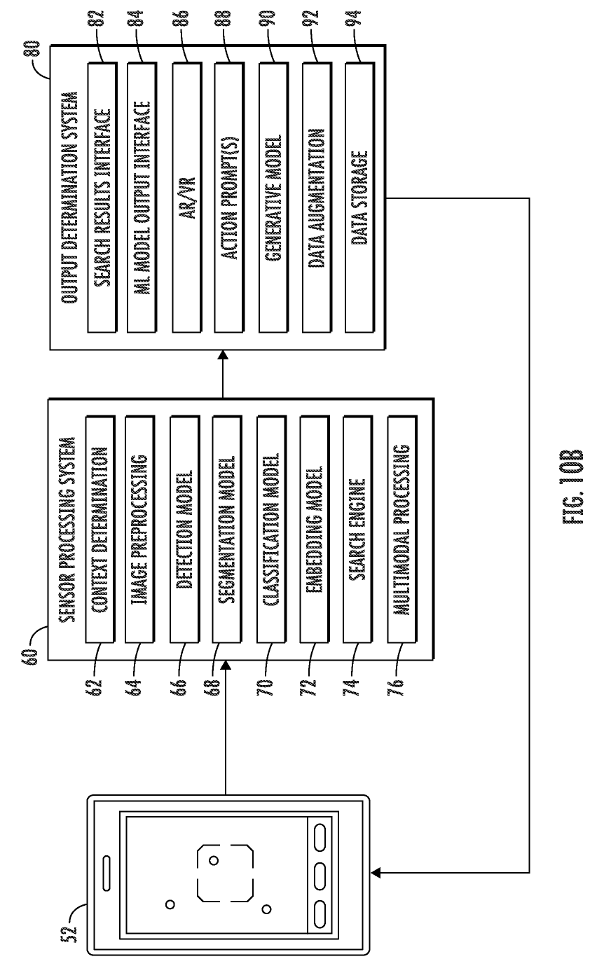

FIG. 10A depicts a block diagram of an example computing system 100 that performs animated image generation according to example embodiments of the present disclosure. The system 100 includes a user computing system 102, a server computing system 130, and/or a third party computing system 150 that are communicatively coupled over a network 180. Additionally and/or alternatively, the user computing system 102, a server computing system 130, and/or a third party computing system 150 can leverage the network 180 to access and search a search database 190 to perform one or more search processing tasks. In some implementations, the search database 190 may be part of and/or communicatively connected to the server computing system 130.

The user computing system 102 can include any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing system 102 to perform operations.

In some implementations, the user computing system 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 120 can be received from the server computing system 130 over network 180, stored in the user computing device memory 114, and then used or otherwise implemented by the one or more processors 112. In some implementations, the user computing system 102 can implement multiple parallel instances of a single machine-learned model 120 (e.g., to perform parallel machine-learned model processing across multiple instances of input data and/or detected features).

More particularly, the one or more machine-learned models 120 may include one or more detection models, one or more classification models, one or more segmentation models, one or more augmentation models, one or more generative models, one or more natural language processing models, one or more optical character recognition models, and/or one or more other machine-learned models. The one or more machine-learned models 120 can include one or more transformer models. The one or more machine-learned models 120 may include one or more neural radiance field models, one or more diffusion models, and/or one or more autoregressive language models.

The one or more machine-learned models 120 may be utilized to detect one or more object features. The detected object features may be classified and/or embedded. The classification and/or the embedding may then be utilized to perform a search to determine one or more search results. Alternatively and/or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 120 can process image data, text data, audio data, and/or latent encoding data to generate output data that can include image data, text data, audio data, and/or latent encoding data. The one or more machine-learned models 120 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Machine-learned model(s) can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) can include a single or multiple instances of the same model configured to operate on data from input(s). Machine-learned model(s) can include an ensemble of different models that can cooperatively interact to process data from input(s). For example, machine-learned model(s) can employ a mixture-of-experts structure. See, e.g., Zhou et al., Mixture-of-Experts with Expert Choice Routing, arXiv:2202.09368v2 (Oct. 14, 2022).

Input(s) can generally include or otherwise represent various types of data. Input(s) can include one type or many different types of data. Output(s) can be data of the same type(s) or of different types of data as compared to input(s). Output(s) can include one type or many different types of data.

Example data types for input(s) or output(s) include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs or outputs, example combinations of data types include image data and audio data, image data and natural language data, natural language data and software code data, image data and biometric data, sensor data and medical data, etc. It is to be understood that any combination of data types in an input or an output can be present.

An example input can include one or multiple data types, such as the example data types noted above. An example output can include one or multiple data types, such as the example data types noted above. The data type(s) of input can be the same as or different from the data type(s) of output. It is to be understood that the example data types noted above are provided for illustrative purposes only. Data types contemplated within the scope of the present disclosure are not limited to those examples noted above.

Additionally, or alternatively, one or more machine-learned models 140 can be included in or otherwise stored and implemented by the server computing system 130 that communicates with the user computing system 102 according to a client-server relationship. For example, the machine-learned models 140 can be implemented by the server computing system 130 as a portion of a web service (e.g., a viewfinder service, a visual search service, an image processing service, an ambient computing service, and/or an overlay application service). Thus, one or more models 120 can be stored and implemented at the user computing system 102 and/or one or more models 140 can be stored and implemented at the server computing system 130.

The user computing system 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the user computing system 102 can store and/or provide one or more user interfaces 124, which may be associated with one or more applications. The one or more user interfaces 124 can be configured to receive inputs and/or provide data for display (e.g., image data, text data, audio data, one or more user interface elements, an augmented-reality experience, a virtual reality experience, and/or other data for display. The user interfaces 124 may be associated with one or more other computing systems (e.g., server computing system 130 and/or third party computing system 150). The user interfaces 124 can include a viewfinder interface, a search interface, a generative model interface, a social media interface, and/or a media content gallery interface.

The user computing system 102 may include and/or receive data from one or more sensors 126. The one or more sensors 126 may be housed in a housing component that houses the one or more processors 112, the memory 114, and/or one or more hardware components, which may store, and/or cause to perform, one or more software packets. The one or more sensors 126 can include one or more image sensors (e.g., a camera), one or more lidar sensors, one or more audio sensors (e.g., a microphone), one or more inertial sensors (e.g., inertial measurement unit), one or more biological sensors (e.g., a heart rate sensor, a pulse sensor, a retinal sensor, and/or a fingerprint sensor), one or more infrared sensors, one or more location sensors (e.g., GPS), one or more touch sensors (e.g., a conductive touch sensor and/or a mechanical touch sensor), and/or one or more other sensors. The one or more sensors can be utilized to obtain data associated with a user’s environment (e.g., an image of a user’s environment, a recording of the environment, and/or the location of the user).

The user computing system 102 may include, and/or be part of, a user computing device 104. The user computing device 104 may include a mobile computing device (e.g., a smartphone or tablet), a desktop computer, a laptop computer, a smart wearable, and/or a smart appliance. Additionally and/or alternatively, the user computing system may obtain from, and/or generate data with, the one or more user computing devices 104. For example, a camera of a smartphone may be utilized to capture image data descriptive of the environment, and/or an overlay application of the user computing device 104 can be utilized to track and/or process the data being provided to the user. Similarly, one or more sensors associated with a smart wearable may be utilized to obtain data about a user and/or about a user’s environment (e.g., image data can be obtained with a camera housed in a user’s smart glasses). Additionally and/or alternatively, the data may be obtained and uploaded from other user devices that may be specialized for data obtainment or generation.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIG. 9B.

Additionally and/or alternatively, the server computing system 130 can include and/or be communicatively connected with a search engine 142 that may be utilized to crawl one or more databases (and/or resources) (e.g., the search database 190). The search engine 142 can process data from the user computing system 102, the server computing system 130, and/or the third party computing system 150 to determine one or more search results associated with the input data. The search engine 142 may perform term based search, label based search, Boolean based searches, image search, embedding based search (e.g., nearest neighbor search), multimodal search, and/or one or more other search techniques.

The server computing system 130 may store and/or provide one or more user interfaces 144 for obtaining input data and/or providing output data to one or more users. The one or more user interfaces 144 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

The user computing system 102 and/or the server computing system 130 can train the models 120 and/or 140 via interaction with the third party computing system 150 that is communicatively coupled over the network 180. The third party computing system 150 can be separate from the server computing system 130 or can be a portion of the server computing system 130. Alternatively and/or additionally, the third party computing system 150 may be associated with one or more web resources, one or more web platforms, one or more other users, and/or one or more contexts.

An example machine-learned model can include a generative model (e.g., a large language model, a foundation model, a vision language model, an image generation model, a text-to-image model, an audio generation model, and/or other generative models).

Training and/or tuning the machine-learned model can include obtaining a training instance. A set of training data can include a plurality of training instances divided between multiple datasets (e.g., a training dataset, a validation dataset, or testing dataset). A training instance can be labeled or unlabeled. The runtime inferences can form training instances when a model is trained using an evaluation of the model’s performance on that runtime instance (e.g., online training/learning). Example data types for the training instance and various tasks associated therewith are described throughout the present disclosure.

Training and/or tuning can include processing, using one or more machine-learned models, the training instance to generate an output. The output can be directly obtained from the one or more machine-learned models or can be a downstream result of a chain of processing operations that includes an output of the one or more machine-learned models.

Training and/or tuning can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

Training and/or tuning can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Training and/or tuning can include implementing a number of generalization techniques (e.g., weight decays, dropouts, etc.) to improve the generalization capability of the models being trained.

In some implementations, the above training loop can be implemented for training a machine-learned model from an initialized state to a fully trained state (e.g., when the model exhibits a desired performance profile, such as based on accuracy, precision, recall, etc.).

In some implementations, the above training loop can be implemented for particular stages of a training procedure. For instance, in some implementations, the above training loop can be implemented for pre-training a machine-learned model. Pre-training can include, for instance, large-scale training over potentially noisy data to achieve a broad base of performance levels across a variety of tasks/data types. In some implementations, the above training loop can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

In some implementations, the computing system 100 may leverage reviews and/or other user-generated content (e.g., link notes) for training and/or model-inference. For example, a user-generated link note can include details provided by a particular user discussing the web resource associated with a particular search result, which the machine-learned model (e.g., 120 and/or 140) can process to identify one or more predicted actions associated with that web resource. The details can include information associated with the quality of the web resource, landing pages utilized, and/or actions performed. A link note can include text provided with the search result information of a search result (e.g., the link note may be provided with the web resource title, hyperlink, and caption). In some implementations, the link note can include a multimodal user-generated content item that may include text overlayed over a graphical card with one or more media content items (e.g., images and/or videos).

In training, the computing system 100 may utilize reviews and/or other user-generated content as quality signals and/or content indicators for training the machine-learned model (e.g., 120 and/or 140). For example, the reviews and/or other user-generated content can include details associated with how a user utilized the web page, what they saw on the web page, and/or their review of the quality of that web resource. The computing system 100 may process the details of the reviews and/or other user-generated content to generate labels for web resources (e.g., a machine-learned model (e.g., 120 and/or 140) may process the details to identify particular actions discussed in the reviews and/or other user-generated content), and the labels may then be utilized for machine-learned model training. Alternatively and/or additionally, the computing system 100 may utilize the reviews and/or other user-generated content as input and/or for input conditioning during training. Moreover, the machine-learned model (e.g., 120 and/or 140) may process the reviews and/or other user-generated content during model-inference to determine, rank, and/or filter predicted actions.

Additionally and/or alternatively, the search results interface may provide one or more link notes for display with the shortcut to the resource locator. The one or more link notes may be general link notes associated with the particular web resource. Alternatively and/or additionally, the one or more link notes may be selected based on the content of the landing page associated with the shortcut (e.g., link notes associated with reserving a table may be identified and provided for display based on the shortcut being associated with a landing page for booking a table at the restaurant associated with the web resource).

In some implementations, the computing system 100 may utilize one or more soft prompts for conditioning the one or more machine-learned models (120 and/or 140) for downstream tasks. The one or more soft prompts can include a set of tunable parameters that can be trained (or tuned) as the parameters of the one or more machine-learned models (120 and/or 140) are fixed. The one or more soft prompts 124 can be trained for a specific task and/or a specific set of tasks. Alternatively and/or additionally, the one or more soft prompts 124 may be trained to condition the one or more machine-learned models (120 and/or 140) to perform inferences for a particular individual, one or more entities, and/or one or more tasks such that the output is tailored for that particular individual, particular entities, and/or particular task. The one or more soft prompts 124 can be obtained and processed with one or more inputs by the one or more machine-learned models (120 and/or 140).

The one or more soft prompts can include a set of machine-learned weights. In particular, the one or more soft prompts can include weights that were trained to condition a generative model to generate model-generated content with one or more particular attributes. For example, the one or more soft prompts can be utilized by a user to generate content based on the fine-tuning. The one or more soft prompts can be extended to a plurality of tasks. For example, the computing system 100 may tune the set of parameters on a plurality of different content attributes and/or types. The one or more soft prompts may include a plurality of learned vector representations that may be model-readable.

A particular soft prompt can be obtained based on a particular task, individual, content type, etc. The particular soft prompt can include a set of learned parameters. The set of learned parameters can be processed with the generative model to generate the model-generated image.

The user computing system 102 and/or the server computing system 130 may store one or more soft prompts associated with the particular user and/or particular task. The soft prompt(s) can include a set of parameters. The user computing system 102 and/or the server computing system 130 may leverage the set of parameters of the soft prompt(s) and a generative model to generate a model-generated content item. In some implementations, the model-generated content item can be generated based on the set of parameters associated with the particular individual and/or task.

The utilization of a soft prompt (i.e., a set of parameters that can be processed with a generative model for downstream task conditioning) can reduce the computational cost for parameter tuning for object-specific content generation by reducing the parameters to be tuned. The set of parameters can be limited and may be adjusted while the parameters of the pre-trained generative model stay fixed. The set of parameters of the soft prompt can be utilized to condition the pre-trained generative model (e.g., the machine-learned image generation model and/or language model) for particular downstream tasks (e.g., response generation and/or image rendering).

In some implementations, the generative language model and/or one or more soft prompts (e.g., a set of machine-learned parameters that can be processed with the input by the generative language model) can be trained to generate content with particular attributes.

In some implementations, the server computing system 130 can include a prompt library. The prompt library can store a plurality of prompt templates (e.g., a plurality of hard prompt templates (e.g., text prompt templates)) and/or a plurality of soft prompts. The plurality of prompt templates can include hard prompt templates (e.g., text string data) that may be combined with the user input to generate a more detailed and complete prompt for the generative model to process. The templates can include text descriptive of the request. The templates may be object-specific, user-specific, and/or content-specific. The plurality of prompt templates may include few-shot examples.

The prompt library can store a plurality of soft prompts. The plurality of soft prompts may be associated with a plurality of different content attributes and/or a plurality of different individuals. The plurality of soft prompts can include learned parameters and/or learned weights that can be processed with the generative model to condition the generative model to generate content items with particular attributes. The plurality of soft prompts may have been tuned by freezing the parameters of a pre-trained generative model, while the parameters of the soft prompt are learned based on a particular task and/or user. The plurality of soft prompts can include a plurality of different soft prompts associated with a plurality of different users and/or a plurality of different sets of users.

The third party computing system 150 can include one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the third party computing system 150 to perform operations. In some implementations, the third party computing system 150 includes or is otherwise implemented by one or more server computing devices.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The network 180 can be utilized to access one or more search databases 190 to perform one or more search-based tasks, which may include web searches, image searches, blockchain searches, image searches, reverse image searches, embedding searches, and/or other searches. The one or more search databases 190 can store web data 192 to be leveraged to determine search results relevant (e.g., responsive) to a search query. The web data 192 can include data descriptive of uniform resource locators, content snippets, cached data, classification labels for the content of a web resource, tags, embeddings associated with web resources, knowledge graphs, titles, authors, content types, and/or other relevant data that may be indexed to determine the topic, content, sentiment, intent, and/or other features of a web resource to then be leveraged for search instances.

The web data 192 can be leveraged to determine search results responsive to a search query. The server computing system 130 (and/or the user computing system 102) can then render a search results interface based on the determined search results. The search results interface can include a search result list, a search result grid, a knowledge panel, search result categories, search result tabs, and/or other user interface configurations and/or elements. The search results interface may display text (e.g., titles and text snippets), hyperlinks, images, videos, audio, animations, carousels, and/or other data.

In some implementations, the search results interface may display one or more link notes 194 associated with the one or more search results. The one or more link notes 194 may be associated with respective web resources that were determined to be responsive to the search query. The link notes 194 may be stored by the search database 190, which may include indexing the respective link notes 194 with other index data for the respective web resources.

Link notes 194 can include user-generated content that was generated (e.g., composed) to be responsive to and/or about a particular web resource. For example, a link note 194 may include a review of the content of a web resource (e.g., a review of a story published on a particular web page). The link note 194 may include details about the web resource provided by one or more users, which may include a breakdown of related topics, a discussion on the credibility of the web resource, a discussion of related works, and/or other details. Link notes 194 can include text, one or more images, one or more videos, audio, multimodal data, and/or other data. Link notes 194 can include graphical cards that may include a background and structured foreground content, which may include text, image(s), video(s), widget(s), link(s), animation(s), and/or other data.

Link notes 194 may be generated based on prompt suggestions provided to a user, which a user may then leverage to craft a link note graphical card. The computing system 100 can leverage context determination (e.g., determining a context a user is likely to provide a note and/or determining a comment gap and/or content gap for a particular link) to determine an input entry interface (e.g., a link note input entry interface) is to be provided and can leverage a generative model (e.g., a large language model) to generate a prompt based on user data (e.g., user search history and/or user browsing history) and/or content data (e.g., the topic of the content and/or the type of content). For example, a user may be prompted in a search results page, during web resource review, and/or upon next search instance to provide a note on a particular web resource (and/or other content item). A prompt can be generated based on previous user notes, previously viewed content, the topic of the content, and/or the type of content to provide the user with a prompt that requests information in a format that causes insightful note generation.

Link notes 194 can provide additional information on a web resource without reviewing the web resource, and the link notes can be provided by other users. The computing system 100 can determine when to provide link notes prompts to users based on contexts determined to be associated with valuable note intake. For example, particular users may provide more trustworthy and/or more detailed information on a particular topic based on previously obtained knowledge and/or based on previously generated notes. Additionally and/or alternatively, particular content types may be determined to be associated with user commenting and/or user confusion.

The prompt provided to the user can “inspire” a user to provide more detailed information and/or may direct a user to leave a note on a particular topic and/or feature of the web resource. A generative model can process user data and/or content data to generate a predicted prompt. In particular, the generative model can leverage a user’s search history, a user’s browsing history, a user’s previous notes, and/or other user data to generate suggested notes, a question to prompt response, and/or a note template. Alternatively and/or additionally, the generative model can leverage semantic understanding of the web resource, topic classification, content type classification, other notes associated with the web resource, and/or other content data to generate suggested notes, a question to prompt response, and/or a note template.

An input entry interface can provide the predicted prompt to a user. The input entry interface can then obtain inputs (e.g., comment input data) from a user to generate user-generated content descriptive of a link note 194. In some implementations, a graphical card can be generated based on the link note 194. The graphical card can include the user-generated content of the link note, user profile identifiers (e.g., a name and/or an image), link information, and/or a graphical background. The link note 194 (and/or the graphical card) can be stored with an association with the web resource. The stored link note 194 (and/or the graphical card) can then be obtained in response to one or more users searching for the web resource and/or one or more users interacting with a notes interface.

Link notes 194 (e.g., link notes obtained from users and/or link notes generated by a generative model) can provide additional information on a web resource, which may inform other users of a relevancy to their request. The link notes 194 can be provided in a search results page and/or may be displayed in a notes interface that can be accessed from a search results page and/or from the web resource. Link notes 194 can be provided in graphical cards, in a text panel in-line with a text snippet, and/or in other formats.

In some implementations, the link notes 194 and/or interactions with the link notes 194 may be utilized to adjust web resource rankings, web resource tagging, web resource embedding, and/or web resource indexing. For example, in some implementations, the link notes 194 can be processed to determine the quality of the web resource. The quality determination may be determined based on processing the link notes with one or more machine-learned models (e.g., a sentiment analysis model, a language model, a classification model, etc.). The link notes 194 may be processed with one or more machine-learned models to determine topics associated with the web resource, determine biases of the web resource, utility of the web resource, and/or the direction of the web resource. The link notes 194 may be utilized for suggesting additional content, may be embedded for embedding based searches, and/or may be utilized for query suggestions.

Link notes 194 in the notes interface may be ranked and/or displayed based on interactions, machine-learned model determined quality, responsiveness to a query, a level of detail, and/or other attributes. In some implementations, link notes 194 generated by a user may be provided to all other users, only users within the user’s social network, and/or only user’s determined to be associated with the user based on interests, location, and/or activity.

Link notes 194 can be utilized for a plurality of different content items and may not be limited to web resources. For example, the computing system 100 can be utilized to generate prompts and/or interfaces for obtaining, inspiring, and/or generating link notes for local files (e.g., on-device documents, images, videos, etc.), intranet files, and/or other content item sources, which may include folders on an external drive, documents on the cloud, etc.

In some implementations, the input interface can include an open ended input interface that provides one or more options for providing user inputs. Alternatively and/or additionally, the input interface can include a plurality of features and/or options for generating user-generated content, which may be utilized for link notes and/or stand alone content. The input interface can include an independent content item user interface that can enable a user to add images, links, and/or different template types of content and can be interactive. The interactive user interface can include image suggestion, template suggestion, text suggestion, layout suggestion, link suggestion, widget suggestions, template suggestion, and/or other options (e.g., other types of suggestions).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, the task can be a generative task, and the one or more machine-learned models (e.g., 120 and/or 140) can be configured to output content generated in view of one or more inputs. For instance, the inputs can be or otherwise represent data of one or more modalities that encodes context for generating additional content.

In some implementations, the task can be a text completion task. The machine-learned models can be configured to process the inputs that represent textual data and to generate the outputs that represent additional textual data that completes a textual sequence that includes the inputs. For instance, the machine-learned models can be configured to generate the outputs to complete a sentence, paragraph, or portion of text that follows from a portion of text represented by inputs.

In some implementations, the task can be an instruction following task. The machine-learned models can be configured to process the inputs that represent instructions to perform a function and to generate the outputs that advance a goal of satisfying the instruction function (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the instructions (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the instructions (e.g., natural language responses, programming language responses, machine language responses, etc.). One or more outputs can be iteratively or recursively generated to sequentially process and accomplish steps toward accomplishing the requested functionality. For instance, an initial output can be executed by an external system or be processed by the machine-learned models to complete an initial step of performing a function. Multiple steps can be performed, with a final output being obtained that is responsive to the initial instructions.

In some implementations, the task can be a question answering task. The machine-learned models can be configured to process the inputs that represent a question to answer and to generate the outputs that advance a goal of returning an answer to the question (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the question (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the question (e.g., natural language responses, programming language responses, machine language responses, etc.). One or more outputs can be iteratively or recursively generated to sequentially process and accomplish steps toward answering the question. For instance, an initial output can be executed by an external system or be processed by the machine-learned models to complete an initial step of obtaining an answer to the question (e.g., querying a database, performing a computation, executing a script, etc.). Multiple steps can be performed, with a final output being obtained that is responsive to the question.

In some implementations, the task can be an image generation task. The machine-learned models can be configured to process the inputs that represent context regarding a desired portion of image content. The context can include text data, image data, audio data, etc. Machine-learned models can be configured to generate the outputs that represent image data that depicts imagery related to the context. For instance, the machine-learned models can be configured to generate pixel data of an image. Values for channels associated with the pixels in the pixel data can be selected based on the context (e.g., based on a probability determined based on the context).

In some implementations, the task can be an audio generation task. Machine-learned models can be configured to process the inputs that represent context regarding a desired portion of audio content. The context can include text data, image data, audio data, etc. The machine-learned models can be configured to generate the outputs that represent audio data related to the context. For instance, the machine-learned models can be configured to generate waveform data in the form of an image (e.g., a spectrogram). Values for channels associated with pixels of the image can be selected based on the context. The machine-learned models can be configured to generate waveform data in the form of a sequence of discrete samples of a continuous waveform. Values of the sequence can be selected based on the context (e.g., based on a probability determined based on the context).

In some implementations, the task can be a data generation task. Machine-learned models can be configured to process the inputs that represent context regarding a desired portion of data (e.g., data from various data domains, such as sensor data, image data, multimodal data, statistical data, etc.). The desired data can be, for instance, synthetic data for training other machine-learned models. The context can include arbitrary data types. The machine-learned models can be configured to generate the outputs that represent data that aligns with the desired data. For instance, the machine-learned models can be configured to generate data values for populating a dataset. Values for the data objects can be selected based on the context (e.g., based on a probability determined based on the context).

The user computing system may include a number of applications (e.g., applications 1 through N). Each application may include its own respective machine learning library and machine-learned model(s). For example, each application can include a machine-learned model. Example applications include a text messaging application, an email application, a dictation application, a virtual keyboard application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 102 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing system 100.

The central intelligence layer can communicate with a central device data layer. The central device data layer can be a centralized repository of data for the computing system 100. The central device data layer may communicate with a number of other components of the computing device, such as, for example, one or more sensors, a context manager, a device state component, and/or additional components. In some implementations, the central device data layer can communicate with each device component using an API (e.g., a private API).

FIG. 10B depicts a block diagram of an example computing system 50 that performs animated image generation and suggestion according to example embodiments of the present disclosure. In particular, the example computing system 50 can include one or more computing devices 52 that can be utilized to obtain, and/or generate, one or more datasets that can be processed by a sensor processing system 60 and/or an output determination system 80 to feedback to a user that can provide information on features in the one or more obtained datasets. The one or more datasets can include image data, text data, audio data, multimodal data, latent encoding data, etc. The one or more datasets may be obtained via one or more sensors associated with the one or more computing devices 52 (e.g., one or more sensors in the computing device 52). Additionally and/or alternatively, the one or more datasets can be stored data and/or retrieved data (e.g., data retrieved from a web resource). For example, images, text, and/or other content items may be interacted with by a user. The interacted with content items can then be utilized to generate one or more determinations.

The one or more computing devices 52 can obtain, and/or generate, one or more datasets based on image capture, sensor tracking, data storage retrieval, content download (e.g., downloading an image or other content item via the internet from a web resource), and/or via one or more other techniques. The one or more datasets can be processed with a sensor processing system 60. The sensor processing system 60 may perform one or more processing techniques using one or more machine-learned models, one or more search engines, and/or one or more other processing techniques. The one or more processing techniques can be performed in any combination and/or individually. The one or more processing techniques can be performed in series and/or in parallel. In particular, the one or more datasets can be processed with a context determination block 62, which may determine a context associated with one or more content items. The context determination block 62 may identify and/or process metadata, user profile data (e.g., preferences, user search history, user browsing history, user purchase history, and/or user input data), previous interaction data, global trend data, location data, time data, and/or other data to determine a particular context associated with the user. The context can be associated with an event, a determined trend, a particular action, a particular type of data, a particular environment, and/or another context associated with the user and/or the retrieved or obtained data.

The sensor processing system 60 may include an image preprocessing block 64. The image preprocessing block 64 may be utilized to adjust one or more values of an obtained and/or received image to prepare the image to be processed by one or more machine-learned models and/or one or more search engines 74. The image preprocessing block 64 may resize the image, adjust saturation values, adjust resolution, strip and/or add metadata, and/or perform one or more other operations.

In some implementations, the sensor processing system 60 can include one or more machine-learned models, which may include a detection model 66, a segmentation model 68, a classification model 70, an embedding model 72, and/or one or more other machine-learned models. For example, the sensor processing system 60 may include one or more detection models 66 that can be utilized to detect particular features in the processed dataset. In particular, one or more images can be processed with the one or more detection models 66 to generate one or more bounding boxes associated with detected features in the one or more images.

Additionally and/or alternatively, one or more segmentation models 68 can be utilized to segment one or more portions of the dataset from the one or more datasets. For example, the one or more segmentation models 68 may utilize one or more segmentation masks (e.g., one or more segmentation masks manually generated and/or generated based on the one or more bounding boxes) to segment a portion of an image, a portion of an audio file, and/or a portion of text. The segmentation may include isolating one or more detected objects and/or removing one or more detected objects from an image.

The one or more classification models 70 can be utilized to process image data, text data, audio data, latent encoding data, multimodal data, and/or other data to generate one or more classifications. The one or more classification models 70 can include one or more image classification models, one or more object classification models, one or more text classification models, one or more audio classification models, and/or one or more other classification models. The one or more classification models 70 can process data to determine one or more classifications.

In some implementations, data may be processed with one or more embedding models 72 to generate one or more embeddings. For example, one or more images can be processed with the one or more embedding models 72 to generate one or more image embeddings in an embedding space. The one or more image embeddings may be associated with one or more image features of the one or more images. In some implementations, the one or more embedding models 72 may be configured to process multimodal data to generate multimodal embeddings. The one or more embeddings can be utilized for classification, search, and/or learning embedding space distributions.

The sensor processing system 60 may include one or more search engines 74 that can be utilized to perform one or more searches. The one or more search engines 74 may crawl one or more databases (e.g., one or more local databases, one or more global databases, one or more private databases, one or more public databases, one or more specialized databases, and/or one or more general databases) to determine one or more search results. The one or more search engines 74 may perform feature matching, text based search, embedding based search (e.g., k-nearest neighbor search), metadata based search, multimodal search, web resource search, image search, text search, and/or application search.

Additionally and/or alternatively, the sensor processing system 60 may include one or more multimodal processing blocks 76, which can be utilized to aid in the processing of multimodal data. The one or more multimodal processing blocks 76 may include generating a multimodal query and/or a multimodal embedding to be processed by one or more machine-learned models and/or one or more search engines 74.

The output(s) of the sensor processing system 60 can then be processed with an output determination system 80 to determine one or more outputs to provide to a user. The output determination system 80 may include heuristic based determinations, machine-learned model based determinations, user selection based determinations, and/or context based determinations.

The output determination system 80 may determine how and/or where to provide the one or more search results in a search results interface 82. Additionally and/or alternatively, the output determination system 80 may determine how and/or where to provide the one or more machine-learned model outputs in a machine-learned model output interface 84. In some implementations, the one or more search results and/or the one or more machine-learned model outputs may be provided for display via one or more user interface elements. The one or more user interface elements may be overlayed over displayed data. For example, one or more detection indicators may be overlayed over detected objects in a viewfinder. The one or more user interface elements may be selectable to perform one or more additional searches and/or one or more additional machine-learned model processes. In some implementations, the user interface elements may be provided as specialized user interface elements for specific applications and/or may be provided uniformly across different applications. The one or more user interface elements can include pop-up displays, interface overlays, interface tiles and/or chips, carousel interfaces, audio feedback, animations, interactive widgets, and/or other user interface elements.

Additionally and/or alternatively, data associated with the output(s) of the sensor processing system 60 may be utilized to generate and/or provide an augmented-reality experience and/or a virtual-reality experience 86. For example, the one or more obtained datasets may be processed to generate one or more augmented-reality rendering assets and/or one or more virtual-reality rendering assets, which can then be utilized to provide an augmented-reality experience and/or a virtual-reality experience 86 to a user. The augmented-reality experience may render information associated with an environment into the respective environment. Alternatively and/or additionally, objects related to the processed dataset(s) may be rendered into the user environment and/or a virtual environment. Rendering dataset generation may include training one or more neural radiance field models to learn a three-dimensional representation for one or more objects.

In some implementations, one or more action prompts 88 may be determined based on the output(s) of the sensor processing system 60. For example, a search prompt, a purchase prompt, a generate prompt, a reservation prompt, a call prompt, a redirect prompt, and/or one or more other prompts may be determined to be associated with the output(s) of the sensor processing system 60. The one or more action prompts 88 may then be provided to the user via one or more selectable user interface elements. In response to a selection of the one or more selectable user interface elements, a respective action of the respective action prompt may be performed (e.g., a search may be performed, a purchase application programming interface may be utilized, and/or another application may be opened).

In some implementations, the one or more datasets and/or the output(s) of the sensor processing system 60 may be processed with one or more generative models 90 to generate a model-generated content item that can then be provided to a user. The generation may be prompted based on a user selection and/or may be automatically performed (e.g., automatically performed based on one or more conditions, which may be associated with a threshold amount of search results not being identified).

The one or more generative models 90 can include language models (e.g., large language models and/or vision language models), image generation models (e.g., text-to-image generation models and/or image augmentation models), audio generation models, video generation models, graph generation models, and/or other data generation models (e.g., other content generation models). The one or more generative models 90 can include one or more transformer models, one or more convolutional neural networks, one or more recurrent neural networks, one or more feedforward neural networks, one or more generative adversarial networks, one or more self-attention models, one or more embedding models, one or more encoders, one or more decoders, and/or one or more other models. In some implementations, the one or more generative models 90 can include one or more autoregressive models (e.g., a machine-learned model trained to generate predictive values based on previous behavior data) and/or one or more diffusion models (e.g., a machine-learned model trained to generate predicted data based on generating and processing distribution data associated with the input data).

The one or more generative models 90 can be trained to process input data and generate model-generated content items, which may include a plurality of predicted words, pixels, signals, and/or other data. The model-generated content items may include novel content items that are not the same as any pre-existing work. The one or more generative models 90 can leverage learned representations, sequences, and/or probability distributions to generate the content items, which may include phrases, storylines, settings, objects, characters, beats, lyrics, and/or other aspects that are not included in pre-existing content items.

The one or more generative models 90 may include a vision language model.

The vision language model can be trained, tuned, and/or configured to process image data and/or text data to generate a natural language output. The vision language model may leverage a pre-trained large language model (e.g., a large autoregressive language model) with one or more encoders (e.g., one or more image encoders and/or one or more text encoders) to provide detailed natural language outputs that emulate natural language composed by a human.

The vision language model may be utilized for zero-shot image classification, few shot image classification, image captioning, multimodal query distillation, multimodal question and answering, and/or may be tuned and/or trained for a plurality of different tasks. The vision language model can perform visual question answering, image caption generation, feature detection (e.g., content monitoring (e.g., for inappropriate content)), object detection, scene recognition, and/or other tasks.

The vision language model may leverage a pre-trained language model that may then be tuned for multimodality. Training and/or tuning of the vision language model can include image-text matching, masked-language modeling, multimodal fusing with cross attention, contrastive learning, prefix language model training, and/or other training techniques. For example, the vision language model may be trained to process an image to generate predicted text that is similar to ground truth text data (e.g., a ground truth caption for the image). In some implementations, the vision language model may be trained to replace masked tokens of a natural language template with textual tokens descriptive of features depicted in an input image. Alternatively and/or additionally, the training, tuning, and/or model inference may include multi-layer concatenation of visual and textual embedding features. In some implementations, the vision language model may be trained and/or tuned via jointly learning image embedding and text embedding generation, which may include training and/or tuning a system to map embeddings to a joint feature embedding space that maps text features and image features into a shared embedding space. The joint training may include image-text pair parallel embedding and/or may include triplet training. In some implementations, the images may be utilized and/or processed as prefixes to the language model.

The one or more generative models 90 may be stored on-device and/or may be stored on a server computing system. In some implementations, the one or more generative models 90 can perform on-device processing to determine suggested searches, suggested actions, and/or suggested prompts. The one or more generative models 90 may include one or more compact vision language models that may include less parameters than a vision language model stored and operated by the server computing system. The compact vision language model may be trained via distillation training. In some implementations, the visional language model may process the display data to generate suggestions. The display data can include a single image descriptive of a screenshot and/or may include image data, metadata, and/or other data descriptive of a period of time preceding the current displayed content (e.g., the applications, images, videos, messages, and/or other content viewed within the past 30 seconds). The user computing device may generate and store a rolling buffer window (e.g., 30 seconds) of data descriptive of content displayed during the buffer. Once the time has elapsed, the data may be deleted. The rolling buffer window data may be utilized to determine a context, which can be leveraged for query, content, action, and/or prompt suggestion.

In some implementations, the generative models 90 can include machine-learned sequence processing models. An example system can pass inputs to sequence processing models. Sequence processing models can include one or more machine-learned components. Sequence processing models can process the data from inputs to obtain an input sequence. Input sequence can include one or more input elements obtained from inputs. The sequence processing model can process the input sequence using prediction layers to generate an output sequence. The output sequence can include one or more output elements generated based on input sequence. The system can generate outputs based on output sequence.

Sequence processing models can include one or multiple machine-learned model components configured to ingest, generate, or otherwise reason over sequences of information. For example, some example sequence processing models in the text domain are referred to as, “Large Language Models,” or LLMs. See, e.g., PaLM2 Technical Report, Google https://ai.google/static/documents/palm2techreport.pdf (n.d.). Other example sequence processing models can operate in other domains, such as image domains, see, e.g., Dosovitskiy et al., An Image is Worth 16x16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing models can process one or multiple types of data simultaneously. Sequence processing models can include relatively large models (e.g., more parameters, computationally expensive, etc.), relatively small models (e.g., fewer parameters, computationally lightweight, etc.), or both.

In general, sequence processing models can obtain an input sequence using data from inputs. For instance, input sequence can include a representation of data from inputs 2 in a format understood by sequence processing models. One or more machine-learned components of sequence processing models can ingest the data from inputs, parse the data into pieces compatible with the processing architectures of sequence processing models (e.g., via “tokenization”), and project the pieces into an input space associated with prediction layers (e.g., via “embedding”).

Sequence processing models can ingest the data from inputs and parse the data into a sequence of elements to obtain input sequence. For example, a portion of input data from inputs can be broken down into pieces that collectively represent the content of the portion of the input data. The pieces can provide the elements of the sequence.

In some implementations, processing the input data can include tokenization. For example, a tokenizer may process a given portion of an input source and output a series of tokens (e.g., corresponding to input elements) that represent the portion of the input source. Various approaches to tokenization can be used. For instance, textual input sources can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66–71 (October 31–November 4, 2018), https://aclanthology.org/D18-2012.pdf. Image-based input sources can be tokenized by extracting and serializing patches from an image.

In general, arbitrary data types can be serialized and processed into an input sequence.

Prediction layers can predict one or more output elements based on the input elements. Prediction layers can include one or more machine-learned model architectures, such as one or more layers of learned parameters that manipulate and transform the inputs to extract higher-order meaning from, and relationships between, input elements. In this manner, for instance, example prediction layers can predict new output elements in view of the context provided by input sequence.

Prediction layers can evaluate associations between portions of input sequence and a particular output element. These associations can inform a prediction of the likelihood that a particular output follows the input context. For example, consider the textual snippet, “The carpenter’s toolbox was small and heavy. It was full of ___.” Example prediction layers can identify that “It” refers back to “toolbox” by determining a relationship between the respective embeddings. Example prediction layers can also link “It” to the attributes of the toolbox, such as “small” and “heavy.” Based on these associations, prediction layers can, for instance, assign a higher probability to the word “nails” than to the word “sawdust.”

A transformer is an example architecture that can be used in prediction layers. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence and potentially one or more output elements. A transformer block can include one or more attention layers and one or more post-attention layers (e.g., feedforward layers, such as a multi-layer perceptron).

Prediction layers can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layers can leverage various kinds of artificial neural networks that can understand or generate sequences of information.

Output sequence can include or otherwise represent the same or different data types as input sequence. For instance, input sequence can represent textual data, and output sequence can represent textual data. The input sequence can represent image, audio, or audiovisual data, and output sequence can represent textual data (e.g., describing the image, audio, or audiovisual data). It is to be understood that prediction layers, and any other interstitial model components of sequence processing models, can be configured to receive a variety of data types in input sequences and output a variety of data types in output sequences.

The output sequence can have various relationships to an input sequence. Output sequence can be a continuation of input sequence. The output sequence can be complementary to the input sequence. The output sequence can translate, transform, augment, or otherwise modify input sequence. The output sequence can answer, evaluate, confirm, or otherwise respond to input sequence. The output sequence can implement (or describe instructions for implementing) an instruction provided via an input sequence.

The output sequence can be generated autoregressively. For instance, for some applications, an output of one or more prediction layers can be passed through one or more output layers (e.g., softmax layer) to obtain a probability distribution over an output vocabulary (e.g., a textual or symbolic vocabulary) conditioned on a set of input elements in a context window. In this manner, for instance, the output sequence can be autoregressively generated by sampling a likely next output element, adding that element to the context window, and re-generating the probability distribution based on the updated context window, and sampling a likely next output element, and so forth.

The output sequence can also be generated non-autoregressively. For instance, multiple output elements of the output sequence can be predicted together without explicit sequential conditioning on each other. See, e.g., Saharia et al., Non-Autoregressive Machine Translation with Latent Alignments, arXiv:2004.07437v3 (Nov. 16, 2020).

The output sequence can include one or multiple portions or elements. In an example content generation configuration, the output sequence can include multiple elements corresponding to multiple portions of a generated output sequence (e.g., a textual sentence, values of a discretized waveform, computer code, etc.). In an example classification configuration, the output sequence can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

The output determination system 80 may process the one or more datasets and/or the output(s) of the sensor processing system 60 with a data augmentation block 92 to generate augmented data. For example, one or more images can be processed with the data augmentation block 92 to generate one or more augmented images. The data augmentation can include data correction, data cropping, the removal of one or more features, the addition of one or more features, a resolution adjustment, a lighting adjustment, a saturation adjustment, and/or other augmentation.

In some implementations, the one or more datasets and/or the output(s) of the sensor processing system 60 may be stored based on a data storage block 94 determination.

The output(s) of the output determination system 80 can then be provided to a user via one or more output components of the user computing device 52. For example, one or more user interface elements associated with the one or more outputs can be provided for display via a visual display of the user computing device 52.

The processes may be performed iteratively and/or continuously. One or more user inputs to the provided user interface elements may condition and/or affect successive processing loops.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

WHAT IS CLAIMED IS:

1. A computing system for generating animated images, the system comprising:
one or more processors; and
one or more non-transitory computer-readable media that collectively store instructions that, when executed by the one or more processors, cause the computing system to perform operations, the operations comprising:
obtaining, via a link notes interface, user-generated content data, wherein the user-generated content data comprises a text string input by a user, wherein the link notes interface comprises a user interface that is configured to receive inputs to generate user generated link notes to index with web resources;
obtaining, via the link note interface, video data, wherein the video data comprises a plurality of image frames and audio data;
processing the user-generated content data and the video data to determine a subset of frames of the plurality of image frames are associated with the user-generated content data;
processing the subset of frames of the plurality of image frames to generate an animated image, wherein the animated image comprises an animated playback of the subset of frames ordered sequentially; and
providing the animated image for display via the link notes interface.

2. The system of claim 1, wherein the operations further comprise:
obtaining a selection of the animated image; and
augmenting, based on the selection of the animated image, a link note to include the animated image and the text string input.

3. The system of claim 1, wherein processing the subset of frames of the plurality of image frames to generate the animated image comprises:
processing the audio data to transcribe at least a portion of the audio data associated with the subset of frames to generate a partial transcript; and
rendering the partial transcript over the subset of frames.

4. The system of claim 1, wherein processing the user-generated content data and the video data to determine the subset of frames of the plurality of image frames are associated with the user-generated content data comprises:
processing the audio data with a transcription model to generate a transcript for the video data; and
processing the transcript and the text string input with a machine-learned language model to determine the subset of frames of the plurality of image frames.

5. The system of claim 1, wherein obtaining, via the link notes interface, the user-generated content data comprises:
receiving the text string input with a freeform input box provided by the link notes interface.

6. The system of claim 5, wherein providing the animated image for display via the link notes interface comprises:
providing the animated image for display within the freeform input box adjacent to the text string input.

7. The system of claim 1, wherein the operations further comprise:
generating a graphical card based on the text string input and the animated image, wherein the graphical card comprises a stylized format of the text string input and the animated image.

8. The system of claim 7, wherein the operations further comprise:
indexing the graphical card with resource data associated with a particular web resource.

9. The system of claim 8, wherein the operations further comprise:
obtaining a search query;
determining the particular web resource is responsive to the search query; and
generating a search results interface that comprises a title for the particular web resource, a text snippet from the particular web resource, a hyperlink to access the particular web resource, and the graphical card.

10. The system of claim 1, wherein the animated image is configured in a graphics interchange format.

11. A computer-implemented method for generating animated images, the method comprising:
obtaining, by a computing system comprising one or more processors and via a link notes interface, user-generated content data, wherein the user-generated content data comprises a text string input by a user, wherein the link notes interface comprises a user interface that is configured to receive inputs to generate user generated link notes to index with web resources;
obtaining, by the computing system and from a video database, a video based on the text string input, wherein the video comprises a plurality of image frames and audio data, wherein the video database comprises a plurality of different videos;
processing, by the computing system, the user-generated content data and the video to determine a subset of frames of the plurality of image frames are associated with the user-generated content data;
processing, by the computing system, the subset of frames of the plurality of image frames to generate an animated image, wherein the animated image comprises an animated playback of the subset of frames ordered sequentially; and
providing, by the computing system, the animated image for display via the link notes interface.

12. The method of claim 11, wherein the video database comprises a user-specific video database that stores videos saved by the user.

13. The method of claim 11, wherein the video database comprises a historical log of videos recently viewed by the user.

14. The method of claim 11, wherein processing, by the computing system, the user-generated content data and the video to determine the subset of frames of the plurality of image frames are associated with the user-generated content data comprises:
determining, by the computing system, a particular sentiment of the text string input; and
determining, by the computing system, the subset of frames of the plurality of image frames are associated with the particular sentiment.

15. The method of claim 11, wherein processing, by the computing system, the user-generated content data and the video to determine the subset of frames of the plurality of image frames are associated with the user-generated content data comprises:
determining, by the computing system, a particular topic of the text string input; and
determining, by the computing system, the subset of frames of the plurality of image frames are associated with the particular topic.

16. The method of claim 11, wherein processing, by the computing system, the user-generated content data and the video to determine the subset of frames of the plurality of image frames are associated with the user-generated content data comprises:
determining, by the computing system, a particular action of the text string input; and
determining, by the computing system, the subset of frames of the plurality of image frames comprises a sequence of frames of an individual performing the particular action.

17. One or more non-transitory computer-readable media that collectively store instructions that, when executed by one or more computing devices, cause the one or more computing devices to perform operations, the operations comprising:
obtaining, via a link notes interface, user-generated content data, wherein the user-generated content data comprises a text string input by a user, wherein the link notes interface comprises a user interface that is configured to receive inputs to generate user generated link notes to index with web resources;
determining a video comprises content associated with at least a subset of text string input, wherein the video data comprises a plurality of image frames and audio data;
processing the user-generated content data and the video to determine a subset of frames of the plurality of image frames are associated with the user-generated content data;
segmenting the subset of frames of the plurality of image frames from the video based on determining the subset of frames of the plurality of image frames are associated with the user-generated content data;
processing the subset of frames of the plurality of image frames to generate an animated image, wherein the animated image comprises an animated playback of the subset of frames ordered sequentially; and
providing the animated image for display via the link notes interface.

18. The one or more non-transitory computer-readable media of claim 17, wherein processing the subset of frames of the plurality of image frames to generate the animated image comprises:
processing at least a subset of the text string input with a text-to-image generation model to generate one or more model-generated images, wherein the one or more model-generated images comprise a plurality of predicted pixels generated based on the text string input; and
generating the animated image based on the subset of frames and the one or more model-generated images.

19. The one or more non-transitory computer-readable media of claim 18, wherein the text-to-image generation model comprises a diffusion model.

20. The one or more non-transitory computer-readable media of claim 18, wherein the animated image comprises the one or more model-generated images interweaved within the subset of frames of the plurality of image frames.
